(19) United States
(12) Patent Application Publication
(10) Pub. No.: US 2025/0355975 A1
(43) Pub. Date: Nov. 20, 2025

(54) CLASSIFICATION USING ARTIFICIAL INTELLIGENCE STRATEGIES THAT RECONSTRUCT DATA USING COMPRESSION AND DECOMPRESSION TRANSFORMATIONS

(71) Applicant: Microtrace, LLC, Minneapolis, MN (US)

(72) Inventors: Chih Lai, Woodbury, MN (US); Blake Maxwell Roeglin, Minneapolis, MN (US); Brian Thomas Bustrom, Mounds View, MN (US); Brian John Brogger, Blaine, MN (US)

(21) Appl. No.: 18/570,632

(22) PCT Filed: Jun. 15, 2022
(86) PCT No.: PCT/US2022/033605

§ 371 Date: Dec. 15, 2023

Related U.S. Application Data
(60) Provisional application No. 63/211,245, filed on Jun. 16, 2021.

(51) Int. Cl. G06F 18/2433; G06N 20/00

(52) U.S. Cl. CPC G06F 18/2433; G06N 20/00

(57) ABSTRACT

The present invention provides AI strategies that can be used to classify samples. The strategies use AI models to transform and reconstruct an input dataset for a sample into a reconstructed dataset. An aspect of the transformation includes at least one compression of data and/or at least one decompression (or expansion) of data. Preferably the transformation involves compressing the data in a plurality of data compression stages and decompressing or expanding the data in a plurality of data decompressing or expansion stages. The advantage of compressing and decompressing the data is that the transformation becomes so complex and uniquely tailored to the trained, authentic samples such that only authentic samples of the associated class or classes are able to be reconstructed with sufficient accuracy to meet a reconstruction error threshold with high classification accuracy. The reconstruction error of other samples outside the associated class or classes generally would not reconstruct accurately enough to meet the reconstruction error threshold.

### PRIORITY

This application is a national phase entry of International Application No. PCT/US2022/033605, filed Jun. 15, 2022, which in turn claims the benefit of U.S. Provisional Patent Application No. 63/211,245 filed on Jun. 16, 2021, entitled “CLASSIFICATION USING ARTIFICIAL INTELLIGENCE STRATEGIES THAT RECONSTRUCT DATA USING COMPRESSION AND DECOMPRESSION TRANSFORMATIONS,” disclosures of which are hereby incorporated by reference in their respective entireties for all purposes.

### FIELD OF THE INVENTION

The present invention relates to artificial intelligence (AI) strategies that are useful to classify samples. The strategies reconstruct data for a sample using a specialized AI model trained with respect to at least one corresponding class in a manner so that the resulting reconstruction error characteristics for samples within the corresponding class or classes are smaller than the reconstruction errors for samples outside the class or classes. Consequently, the reconstruction error characteristics of samples are indicative of their classification. Advantageously, the AI models can be trained to provide accurate classification using only samples within the class or classes without any need to train with one or more samples outside the class or classes.

### BACKGROUND OF THE INVENTION

A variety of classification strategies may be used to classify samples into one or more classes of interest or to determine that sample(s) are not in those one or more classes. As one illustrative strategy, classification may use artificial intelligence (AI) models to evaluate characteristics of a sample and to use the results to classify a sample. Machine learning (ML) is a type of artificial intelligence involving algorithms that improve automatically through experience and learning from the use of data. For example, ML or other AI approaches have been used to classify companies into one of several credit rankings based on performance. Similar approaches also have been used to classify patients into one of few diagnoses based on test results. In the security industry, it would be helpful to be able to classify a product to confirm whether it is authentic or a counterfeit. It also would be helpful to be able to apply classification strategies in a variety of other applications, including to confirm identity and reduce the risk of identity theft, to classify gemstone origin or provenance (e.g., to classify the origin of diamonds from different mines), to evaluate sound waves from machines (such as to identify ships or other vehicles, to evaluate proper function, etc.), to evaluate biometrics, to evaluate taggant signals, to evaluate natural and man-made materials, to evaluate product freshness, to evaluate degradation, to accomplish bio-detection, and the like.

AI models generally are trained using training data obtained from suitable training samples. If enough training data is provided that contains descriptive information (i.e., variables) of each sample and its corresponding sample class, the ML or AI models can learn the hidden relations among the variables and the sample class for the purpose of classification. An AI model generally has an architecture that includes a large amount of inter-connected artificial neurons to learn the hidden, non-linear relations for the classification tasks. An AI model also is known as an artificial intelligence neural network (ANN) or as a deep neural network.

In the field of artificial intelligence, a typical AI model includes a number of attributes or characteristics. A first attribute is an input layer, or input dataset, that includes the input data values that are supplied to the AI model for evaluation. A typical AI model also includes one or more hidden layers that transform the input data in order to generate output data to an output layer that includes the output values resulting from the transformation. Each hidden layer typically includes an array of nodes, or neurons. The number of nodes and the array size in each hidden layer may be the same or different from hidden layer to hidden layer. A classification decision can be made based on the output results or from information derived from the output results.

The nodes among the hidden layers are connected to each other and to the input and output layers by pathways or links along which the data flows. A flow of data, often via a plurality of links, is provided as an input to each node. Each node applies a transformation to the data to produce a transformed output. The output of each node may be referred to in the field of artificial intelligence as its activation value or its node value. The activation value of each node often is supplied to a plurality of other nodes in one or more other hidden layers and/or to the output layer. A typical AI model also includes weights, biases, parameters, and other characteristics associated with the pathways and nodes.

An AI model generally must be trained in order to generate accurate results. Training occurs by using the AI model to process training data obtained from one or more training samples. During the training process, an AI model often learns by gradually tuning the weights and biases of the hidden layers. Often, the weight and bias characteristics are tuned as a function of information including at least the error characteristics of the output values in the output layer. In some instances, an AI model incorporates a so-called loss function that helps to reduce the error of the neural network.

According to a conventional practice, a trained AI model may then be used to classify one or more samples, whose classifications are to be determined. Many conventional AI models use probability calculations in order to accomplish classification. The AI model uses characteristics of a sample as an input to the input layer and then computes the probabilities of the sample belonging to one or more sample classes for which the AI model was trained. A sample often will be predicted (i.e. classified) into the class that has the highest probability. For example, consider a study in which it is desired to classify samples into one of the illustrative classes T1, T2, or T3. If application of the model determines that the probabilities of a particular sample belong to one of classes T1, T2, and T3 are 0.31, 0.64, and 0.05, respectively, the sample will be classified (i.e. predicted) into class T2 inasmuch as the class T2 has the highest probability of 0.64. This classification process is referred to as “probabilistic classification” herein.

The transformation of input data to obtain results in an ANN is done by a sequence of mathematic transformations that occur over the layers in the neural network. To show how this can be accomplished via conventional probabilistic classification approaches, Formula (1) below describes an illustrative transformation function F(X) in an AI model that processes each input sample X through its n hidden layers of neurons. The value of n often is at least 1, or even at least 2, or even at least 10, or even at least 100. The value of n can be as high as 1000, or even 10,000, or even 100,000, or even 1,000,000 or more. The variable bⱼ represents the biases of all neurons at layer j, where j=1 to n. Moreover, the variable xᵢ represents the i^{th} value from the input sample, and ⊕_{n,n-1} represents the weights on the connections between neurons at layer n and n−1.

$$F ( X ) = {Z}_{n} = [ σ ( {\sum }_{n - 1} {θ}_{n , n - 1} [ … [ σ ( {\sum }_{1} {θ}_{2 , 1} [ σ ( {\sum }_{i} {x}_{i} {θ}_{i , 1} + {b}_{1} ) ] + {b}_{2} ) ] … ] + {b}_{n} ) ] \qquad formula ( 1 )$$

The output values Zn at the final layer n are then input into a Softmax function or similar function to compute the probabilities of the input sample belonging to each class. The Softmax function listed in formula (2) below normalizes the output values Zn at the final n^{th} layer into individual probabilities that sum to 1.

$$SM ( {z}_{j} ) = \frac{{e}^{{z}_{j}}}{{\sum }_{j} {e}^{{z}_{j}}} , where {z}_{j} ∈ {Z}_{n} \qquad formula ( 2 )$$

Probabilistic classification has a number of drawbacks, including accuracy issues. For example, one accuracy issue occurs when attempting to distinguish authentic products from counterfeit products when a taggant system is affixed to authentic products. A taggant system generally includes one or more taggant compounds that emit unique spectral characteristics. The spectral characteristics provide a unique spectral signature that can be associated with the authentic products. The spectral signature desirably is difficult to reverse engineer accurately, so that the presence of a proper spectral signature indicates with high likelihood that a product is authentic. In practical effect, the spectral signature is analogous to a unique fingerprint to allow the tagged substrate to be authenticated, identified, or otherwise classified.

In some instances, an authentic source may use a single taggant system to mark multiple product offerings with the same spectral signature. In other instances, a library of different taggant systems may be used by an authentic source with respect to one or multiple products.

Any taggant deployment strategy creates a need to be able to authenticate one or more spectral signatures in the marketplace. Counterfeiters, though, may attempt to fake the spectral signature or may even distribute counterfeit products that are untagged (e.g., have no taggant system and hence no spectral signature). This makes it desirable to be able to accurately authenticate spectral signatures so that authentic products can be distinguished from fakes.

In theory, if a fake taggant system is different enough from all of the authentic taggant systems, evaluation of the spectral characteristics of the fake by a trained AI model should produce very low probabilities with respect to all the classes that were used in the training process. For example, an AI model may be trained with respect to three different, authentic taggant systems identified as the T1, T2, and T3 systems or classes, respectively, When the AI model is applied to a product whose authenticity is at issue, the model may predict low probabilities for each of the three classes if the product is a fake. In an illustrative scenario, the AI model might predict relatively low probabilities of 0.33, 0.40, and 0.27 for the T1, T2, and T3 classes, respectively. Since all the probabilities in this illustrative scenario are lower than a specification threshold for authenticity, e.g., an illustrative specification might require a probability of 0.8 or more for a product to be classified into one of the authentic classes, the product sample will be classified as a counterfeit product with a fake taggant system in this scenario.

However, an undesirable situation can occur when a counterfeit product uses a fake taggant system that has a relatively high degree of similarity to the taggant system for at least one authentic class (e.g., T1 for purposes of discussion) while being extremely dissimilar to the rest of the tagged types (e.g., T2 and T3 for purposes of discussion) in the other authentic classes. Under this situation, the normalization process in the Softmax function could output a relatively high probability for the T1 class along with very low probabilities for the T2 and T3 types. This could result in a false positive by which, the counterfeit product is improperly classified as belonging to the type T1 class. This kind of false positive is referred to as the “skewed normalization problem” herein.

Unfortunately, in the real world many counterfeit products with fake taggant systems can have a relatively higher degree of similarity to one authentic tagged type while being extremely dissimilar to the rest of the authentic tagged types used in the training process. This means that the skewed normalization problem can occur too frequently when using traditional probabilistic classification strategies. As a result, many counterfeit products can be falsely classified as authentic samples, impacting the accuracy of the classification task. Using the probabilistic classification method, it has been found through experience that it is very hard to improve the classification accuracy over a satisfactory threshold.

As a practical matter, the false positive risk associated with the skewed normalization problem may further lead to a false negative problem. With the accuracy of probabilistic classification being relatively low, less strict specifications may be used to define an authentic spectral signature in order to minimize the false negative risk that an authentic signature will be classed as a fake signature. Unfortunately, defining a spectral signature so broadly to avoid false negatives sets up a very large area for counterfeiters to invade with fakes to make the false positive risk even worse. It would be desirable to have an evaluation strategy with improved accuracy so that authentic spectral signatures can be defined more tightly to make less room for fakes.

Attempts can be made to overcome the skewed normalization problem and thereby mitigate its impact on false positives and false negatives. One expensive solution to the skewed normalization problem is to build multiple probabilistic classification models where each model only tries to classify the input samples into either the type it can recognize or the type it cannot recognize. Under this approach, a working hypothesis is that untagged counterfeit samples may have high probability to be classified as unrecognizable by all the models (i.e. rejected by all models). However, the training process for this approach can be very long and expensive. This is because, for training one model for recognizing one type versus the other types, it is still necessary to use samples for all types. In other words, authentic samples inside the class or classes as well as non-authentic samples outside the class or classes are needed to train. Yet, the future counterfeit samples that might be encountered later in time are unknown and unavailable to accomplish such training. A training process could include surrogate counterfeit samples as guesses of what might be encountered at a future time. However, the AI models would be trained only with respect to these predicted, surrogate counterfeit samples, not with respect to the future, actual fakes yet to be encountered. Hence, even if training might include the surrogate samples, the training could lead to unsatisfactory counterfeit detection in actual practice.

Hence, there remains a strong need for AI model systems and strategies that can classify samples more accurately than is experienced with conventional probabilistic classification. There also remains a strong need for AI model systems and strategies that are less vulnerable to the skewed normalization problem.

### SUMMARY OF THE INVENTION

The present invention provides AI strategies that can be used to classify samples. The strategies use AI models to transform and reconstruct an input dataset for a sample into a reconstructed dataset. An aspect of the transformation includes at least one compression of data and/or at least one decompression (or expansion) of data. Preferably the transformation involves compressing the data in a plurality of data compression stages and decompressing or expanding the data in a plurality of data decompressing or expansion stages. For example, a data compression occurs when a hidden layer of the AI model has a smaller number of nodes compared to an immediately upstream layer, which may be another hidden layer or the input data layer, as the case may be. Similarly, a data decompression or expansion occurs when a hidden layer or the output layer, as the case may be, has a greater number of nodes compared to an immediately upstream layer, which may be another hidden layer or the input data layer, as the case may be. The compression and decompression/expansion of data may occur in any order. The advantage of compressing and decompressing the data is that the transformation becomes so complex and uniquely tailored to the trained, authentic samples such that only authentic samples of the associated class or classes are able to be reconstructed with sufficient accuracy to meet a reconstruction error threshold with high classification accuracy. The reconstruction error of other samples outside the associated class or classes generally would not reconstruct accurately enough to meet the reconstruction error threshold.

Consequently, the reconstruction error characteristics between the reconstructed dataset and the input dataset indicate the classification of the sample with high accuracy and precision. The strategies are much less vulnerable to the skewed normalization problem than probabilistic classification strategies. Additionally, the enhanced accuracy allows spectral signatures to be defined under stricter specifications to minimize the risks of both false positives (identifying a fake as an authentic item) and false negatives (identifying an authentic item as a fake).

In one preferred embodiment, the input data layer is compressed through a plurality of hidden layers of the AI model until a maximum degree of data compression occurs. Then, the compressed data is decompressed through a plurality of hidden layers until a reconstructed dataset matching the input dataset in size is obtained. In another illustrative embodiment, the input dataset could be decompressed through a plurality of hidden layers after which the resultant expanded dataset is compressed through a plurality of hidden layers to provide a reconstructed dataset that matches the input dataset in size. Using a plurality of compression and decompression/expansion stages enhances the specialization by which the AI models accurately reconstruct data for authentic samples.

In preferred aspects the technical solution of the present invention is based at least in part on the idea that an AI model is trained to accurately transform and reconstruct input data from one or more associated class types with the goal of minimizing the amount of reconstruction error between the starting input data and the reconstructed data. Due to the training and specialization of the AI model, the reconstruction is most accurate with respect to samples in the one or more class types associated with the trained model. Samples outside the associated class or classes will reconstruct less accurately.

Since a specialized AI model of the present invention is trained and specialized to minimize the reconstruction error of samples from one or more associated class types, training is simplified. Only samples from the associated class type or types are needed to train the specialized model. This will greatly reduce the computation cost and effort associated with training. Alternatively, when multiple classes are at issue, rather than associate multiple classes with a single AI model, multiple specialized models can be trained, wherein each model specializes with respect to one class. Moreover, since this reconstruction approach does not need to rely on probabilities relative to two or more classes as does probabilistic classification, the samples of other types have no influence on the training process of a particular type. As another significant advantage, an AI model can be effectively trained using only samples within the associated class or classes. Consequently, it is not necessary to train the AI model using actual or predicted counterfeits or other samples outside the associated class(es). The ability to train without such other samples is beneficial, because some types of samples may not be encountered and not even be known with certainty until some point in the future. This means there is no need to know or try to predict future counterfeits or similar variants to accomplish training.

After the training, a specialized AI model trained for a class, e.g., a class designated as class “T” for purposes of illustration, the lowest reconstruction errors from the model are expected with respect to samples of the type T. Similarly, relatively higher reconstruction errors would be expected from samples that are outside the type T class.

As a result, the strategies of the present invention can better handle the situations in which a third-party sample is relatively closer to samples of one authentic type than to samples of all other types. In particular, the strategies of the present invention can help to avoid the skewed normalization problem. The skewed normalization problem associated with probabilistic classification occurs due to at least two reasons. First, a single classification model is forced to consider all possible classes. Second, the normalization process in the Softmax function is forced to choose a class for an input sample even though the sample is just relatively closer to one authentic type than the rest of the authentic types. In contrast to probabilistic classification, the present invention uses specialized models that allow evaluations to occur based on reconstruction error rather than probabilities.

Advantageously, in one aspect the principles of the present invention provide a self-authenticating technology based on AI models trained to transform and reconstruct input data from a sample using artificial intelligence strategies. These models in practical effect allow any sample, whether an item or person, to be compared to itself to determine its authenticity. When comparing reconstructed data to the input data obtained from the sample, counterfeits or imposters, even close ones, produce a vastly different reconstruction result than an authentic target with improved accuracy as compared to probabilistic classification. This makes fakes easy to identify and reject. With the specialized AI model on hand, the input dataset can be obtained from the sample under evaluation, and then the reconstructed dataset can be derived from that input dataset. Authentication does not require referencing or accessing any authentic records, which remain safely hidden and secure. The sample under evaluation need not be directly compared to an authentic sample. Rather, from one perspective, it is sufficient to compare the sample to a reconstructed version of itself, where the AI model is used to create the reconstructed version from the sample itself.

The practice of the present invention provides several additional benefits. The specialized AI models can be publicly distributed without putting the original source information, or security of the platform, at risk. Individual records are never accessed or used for classification or authentication, thereby providing high levels of data security. Client privacy is enhanced because original source information need not be accessed. Verification may be done without accessing a remote database as the input data is obtained from the sample, person, or other substrate to be classified, identified, authenticated, verified, or otherwise evaluated. An internet or network connection while doing classification or authentication is not required as classification or authentication can take place onsite. This means internet or network connections can be lost or unavailable and this system still works. The technology offers faster processing, a significant advantage, when processing large crowds at airports, sporting events, concerts, places of business, etc. The technology also provides advantages for smaller venues such as restaurants, or the like as the AI models can be stored and used from portable devices such as smart phones and an appropriate mobile app.

The technology can be used in a variety of applications such as for the classification, identification, authentication, verification, evaluation of gemstone origin and/or provenance (e.g., diamonds, pearls, and the like), taggant signatures, to evaluate sound waves from machines (such as to identify ships or other vehicles, to evaluate proper function, etc.), to evaluate biometrics, to evaluate taggant signals, to evaluate natural and man-made materials, to evaluate product freshness, to evaluate degradation, to accomplish bio-detection, and the like. The technology also may be used for high speed scanning, a capability useful with respect to quality control, conveyor scanning, manufacturing, product sorting, and the like. The technology can be used to monitor subject matter that changes spectrally, acoustically, or via other waveform over time, such as the progress or completion of a chemical reaction, the freshness of food or beverage items, and the like.

In one aspect, the present invention relates to a system for evaluating the identity of a sample, said system comprising a computer network system comprising at least one hardware processor operatively coupled to at least one memory, wherein the hardware processor is configured to execute steps comprising the following instructions stored in the at least one memory:
a) receiving an input dataset that characterizes the sample;
b) accessing an artificial intelligence (AI) model uniquely trained and associated with at least one corresponding class in a manner such that the AI model transforms information comprising the input dataset into a reconstructed dataset using a transformation that comprises compressing/shrinking and decompressing/expanding a data flow derived from the information comprising the input data set to provide the reconstructed dataset, wherein a reconstruction error between the reconstructed dataset and the input dataset is indicative of whether the sample is in the at least one corresponding class;
c) using the AI model to transform the information comprising the input dataset into the reconstructed dataset;
d) using information comprising the reconstructed dataset to determine the reconstruction error; and
e) using information comprising the reconstruction error to determine information indicative of whether the sample is in the at least one corresponding class.

In another aspect, the present invention relates to a method for determining whether a sample is in a class, comprising the steps of:
a) providing an input dataset that comprises information indicative of characteristics associated with the sample;
b) transforming information comprising the input dataset to provide a reconstructed dataset, said transforming comprising compressing and decompressing a flow of data derived from information comprising the input dataset, wherein a reconstruction error associated with the reconstructed dataset is indicative of whether the sample is in the class; and
c) using information comprising the reconstruction error to determine if the sample is in the class.

In another aspect, the present invention relates to a method of making a system that determines information indicative of whether a sample is in a class, comprising the steps of:
a) providing a training sample set comprising at least one training sample associated with the class;
b) providing an input dataset that characterizes a corresponding training sample of the training sample set;
c) providing an artificial intelligence (AI) model that transforms the input dataset into compress and decompress expand a flow of data a reconstructed dataset, wherein the transforming comprises compressing a flow of data and decompressing or expanding a flow of data, and wherein a reconstruction error associated with the reconstructed dataset characterizes differences between the input dataset and the reconstructed dataset; and
d) using information comprising the input dataset to train the AI model such that the reconstruction error is indicative of whether the sample is in the associated class.

In another aspect, the present invention relates to a method of making a system that determines information indicative of whether a sample is in a class associated with an authentic taggant system, comprising the steps of:
a) providing at least one training sample, wherein the training sample comprises the authentic taggant system, and wherein the authentic taggant system exhibits spectral characteristics associated with an authentic spectral signature;
b) providing information comprising an input dataset for the training sample, wherein the input dataset comprises information indicative of the spectral characteristics exhibited by the authentic taggant system;
c) providing an artificial intelligence (AI) model that compresses and decompresses/expands a flow of data to provide a reconstructed dataset, wherein a reconstruction error associated with the reconstructed data set characterizes differences between the input dataset and the reconstructed dataset; and
d) using information comprising the input dataset to train the AI model such that the reconstruction error is indicative of whether the sample is in the associated class.

In another aspect, the present invention relates to a classification system for determining information indicative of whether a sample is in an authentic class, said classification system comprising:
a) an authentic taggant system associated with the authentic class, wherein the authentic taggant system exhibits spectral characteristics associated with an authentic spectral signature;
b) a computer network system comprising at least one hardware processor operatively coupled to at least one memory, wherein the hardware processor is configured to execute steps comprising the following instructions stored in at least one memory:
   i. accessing an artificial intelligence (AI) model trained and associated with the authentic class in a manner such that the AI model transforms an input dataset for the sample into a reconstructed dataset using a transformation that comprises compressing/shrinking and decompressing/expanding a data flow comprising the input dataset to provide the reconstructed dataset, wherein the input dataset comprises spectral information associated with the sample, and wherein a reconstruction error between the reconstructed dataset and the input dataset is indicative of whether the sample is inside or outside the authentic class;
   ii. using the AI model and information comprising the input dataset and to obtain the reconstructed dataset;
   iii. using information comprising the reconstructed dataset to determine the reconstruction error; and
   iv. using information comprising the reconstruction error to determine information indicative of whether the sample is inside or outside the authentic class.

### BRIEF DESCRIPTION OF THE DRAWINGS

FIG. 1 schematically illustrates a taggant library including a plurality of taggant systems.

FIG. 2a schematically illustrates a marketplace in which taggant library can be deployed on an authentic product line.

FIG. 2b schematically illustrates a marketplace in which taggant library can be deployed in authentic consumables used in a hardware device.

FIG. 3 schematically illustrates a system of the present invention that uses specialized AI models to classify samples into one or more classes.

FIG. 4 schematically shows exemplary classification results when using the system of FIG. 3.

FIG. 5a illustrates a reconstruction error profile when reconstruction error characteristics of a sample are plotted as a function of wavelength with respect to an illustrative T1-specialized AI model.

FIG. 5b illustrates a reconstruction error profile when reconstruction error characteristics of a sample are plotted as a function of wavelength with respect to an illustrative T2-specialized AI model.

FIG. 5c illustrates a reconstruction error profile when reconstruction error characteristics of a sample are plotted as a function of wavelength with respect to an illustrative T3-specialized AI model.

FIG. 6 schematically illustrates a method of using the system of FIG. 3 to classify samples.

FIG. 7 schematically illustrates a system used to train the system of FIG. 3.

FIG. 8a schematically illustrates the architecture of the AI model of FIG. 7 in more detail.

FIG. 8b schematically illustrates an architecture of an alternative embodiment of an AI model of the present invention.

FIG. 9 schematically shows details of a neural network encoding portion of the present invention and an exemplary set of operations performed on an input dataset to obtain a compressed dataset.

FIG. 10 schematically shows details of a neural network decoding portion of the present invention and an exemplary set of operations performed on a compressed dataset to obtain a reconstructed, output dataset.

FIG. 11a schematically illustrates how a plurality of trained AI models may be used to classify a plurality of samples.

FIG. 11b shows illustrative results that may be obtained by use of the trained AI models of FIG. 11a.

FIG. 12 schematically illustrates a system of the present invention in which gemstones are classified using principles of the present invention.

FIG. 13 schematically illustrates a system of the present invention in which gemstones are classified remotely from a distance based on hyperspectral characteristics of taggants respectively associated with the gemstones.

FIG. 14 shows seven graphs of reconstruction errors resulting when samples from 8 different classes (the seven T1 through T7 classes corresponding to seven different taggant systems T1 through T7, respectively, and an 8^{th} class of untagged samples) are evaluated using seven specialized AI models of the present invention (the T1 through T7 models) that are trained to specialize with respect to the T1 through T7 classes, respectively.

FIG. 15 schematically illustrates how horizontal standardization is applied to a range of samples in three different classes for purposes of training and then how horizontal standardization is applied when testing a sample to determine its classification.

FIG. 16 schematically illustrates how vertical standardization is applied to a range of samples in three different classes for purposes of training and then how vertical standardization is applied when testing a sample to determine its classification.

### DETAILED DESCRIPTION OF PRESENTLY PREFERRED EMBODIMENTS

The present invention will now be further described with reference to the following illustrative embodiments. The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

For purposes of illustration, the principles of the present invention will be described with respect to using taggant systems to help classify products into one or more authentic classes or to determine that a particular product is outside any authentic class. Such classification has many applications, including to help identify authentic products, to help identify competitor products, or to identify counterfeit products that attempt to masquerade as the authentic products. The classification strategies can also be used to help confirm identity and reduce the risk of identity theft. The classification strategies can be used to monitor how counterfeits, competitive samples, or the like evolve over time, including to evaluate if any might become closer over time to the authentic products. The classification strategies can be used to monitor how authentic samples might evolve, degrade, or otherwise change over time. This knowledge can be used to provide supplemental training to make the associated AI models more accurate with respect to recognizing authentic samples that themselves change over time for one reason or another.

The classification strategies of the present invention also can involve follow up evaluations depending upon a classification result for an unknown sample. Such follow up evaluations are useful, as one example, when a reconstruction result provided by an AI model is relatively close (e.g., within 20%, or even within 10%, or even within 5%, or even within 2%) to an applicable reconstruction specification that sets up a boundary with respect to samples inside and outside an associated class. For example, reconstruction results can be above or below the applicable reconstruction specification. If a reconstruction result is relatively close to the reconstruction specification, then this could trigger follow up action to evaluate that sample further using one or more types of testing in order to confirm if the sample is within the associated class or not. Such follow up action can greatly improve the accuracy of classification inasmuch as classification errors would tend to occur only with respect to samples whose reconstruction errors are relatively close to the reconstruction specification. When further evaluation indicates a sample is within the associated class, then data from that sample can be used to help update the training for the AI model.

This is just one way in which training for an AI model can be updated over time. There are other situations in which updated training of an AI model can occur. For example, if authentic samples tend to change over time, data from the changed samples can be used to update training. In some instances, if changes are significant enough, the data from changed samples can be used to train an additional AI model to recognize authentic samples with those changes.

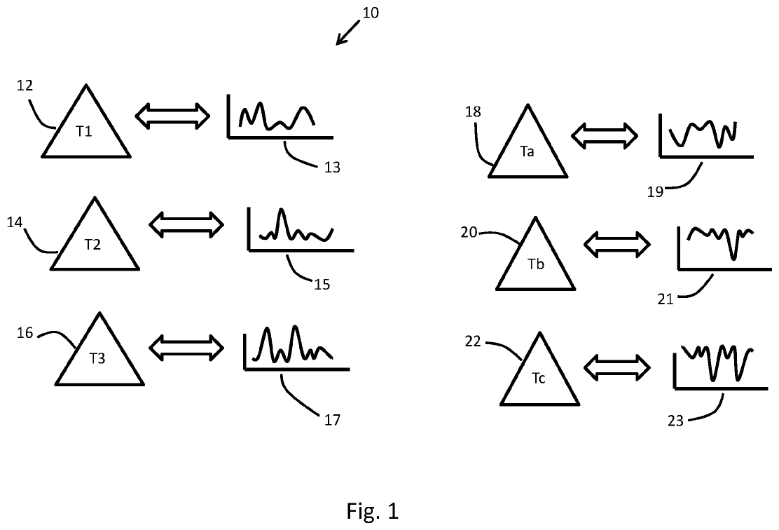

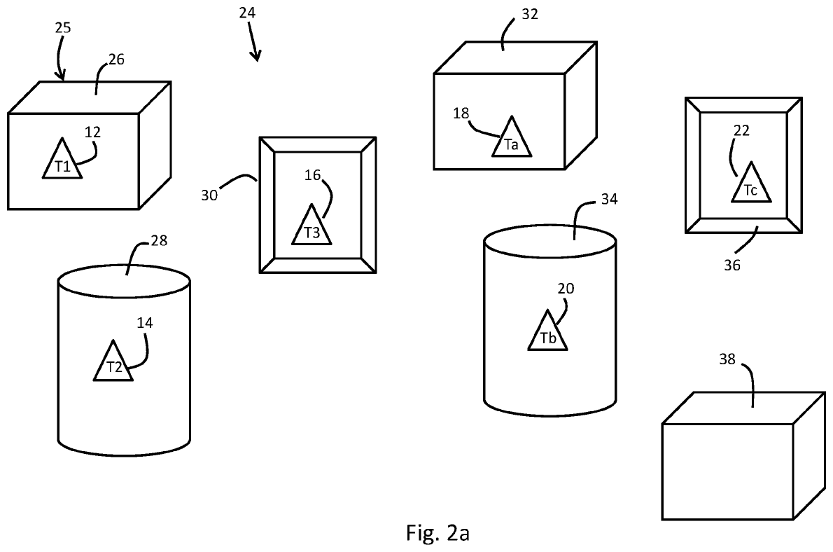

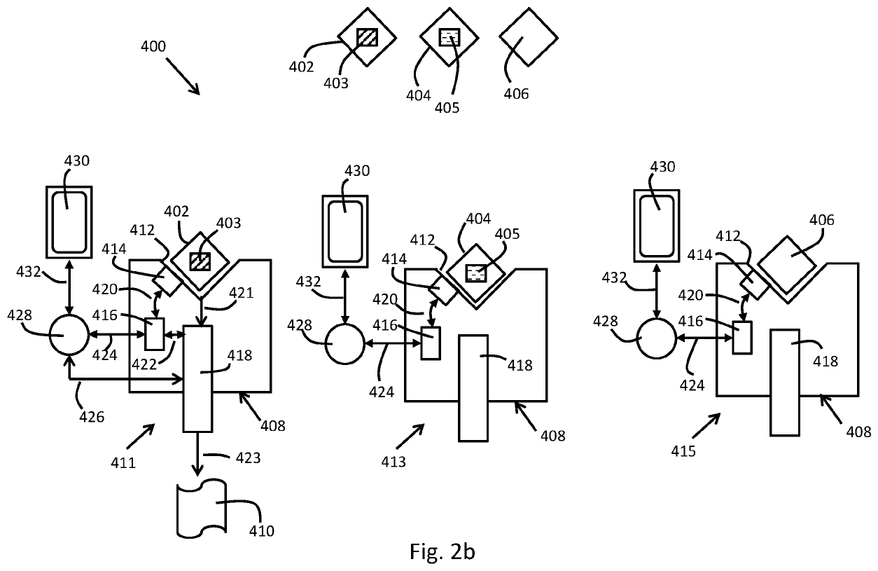

FIGS. 1 and 2a schematically illustrate an authentic taggant library 10 including, for purposes of illustration, multiple taggant systems 12 (T1 class), 14 (T2 class), and 16 (T3 class) and how these taggant systems 12, 14, and 16 can be deployed with respect to an authentic product line 24 (FIG. 2a). The principles of the present invention allow a sample, or samples, whose class is unknown, to be evaluated and then accurately classified as being within one of the authentic T1, T2, or T3 classes or classified as being outside of any of these authentic classes.

Referring first to FIG. 1, authentic taggant library 10 incorporates at least one taggant system. Preferably, taggant library 10 incorporates a plurality of taggant systems. For purposes of illustration, taggant library 10 is shown as including three different, authentic taggant systems 12 (associated with the T1 class), 14 (associated with the T2 class), and 16 (associated with the T3 class). Each of taggant systems 12, 14, and 16 exhibits spectral characteristics in the form of spectra 13, 15, and 17, respectively. For purposes of illustration, each spectrum 13, 15, and 17 is a plot of an optical spectral characteristic, such as intensity, as a function of wavelength.

Each spectrum 13, 15, and 17 is unique with respect to the other taggant system spectra of the taggant library 10. The uniqueness of each spectrum 13, 15, and 17 allows each spectrum to be associated with a corresponding, unique spectral signature. Using principles of the present invention, the different spectral signatures can be uniquely identified, or classified, and distinguished from other signatures in the same library 10. The authentic spectral signatures also can be distinguished from other signatures outside the library 10, such as counterfeit signatures, or from situations in which no spectral signature is present. Further details of taggant systems and their constituents are described in Applicant's co-pending patent applications PCT Pub. No. WO 2021/055573; PCT Pub. No. WO 2020/263744; and PCT Pub. No. WO 2021/041688.

Although FIG. 1 shows each taggant system 12, 14, and 16 as providing spectral signatures based on optical spectral characteristics (e.g., spectral characteristics in the ultraviolet, visible, and/or infrared portions of the electromagnetic spectrum), spectral signatures useful in the practice of the present invention may be based on a wide variety of spectroscopy types or combinations thereof. Examples of spectroscopy types useful in the practice of the present invention include one or more of nuclear magnetic resonance (NMR) spectroscopy, Raman spectroscopy, Mossbauer spectroscopy, laser induced breakdown spectroscopy (LIBS), mass spectroscopy, absorption spectroscopy, reflectance spectroscopy, astronomical spectroscopy, atomic absorption spectroscopy, circular dichroism spectroscopy, electrochemical impedance spectroscopy, electron spin resonance spectroscopy, emission spectroscopy, energy dispersive spectroscopy, fluorescence spectroscopy, Fourier-transform infrared spectroscopy, gamma-ray spectroscopy, infrared spectroscopy, molecular spectroscopy, magnetic resonance spectroscopy, photoelectron spectroscopy, ultraviolet spectroscopy, visible light spectroscopy, x-ray photoelectron spectroscopy, combinations of these, and the like. In each case, the appropriate spectra of training samples from a particular class or classes are used to train an AI model to accurately reconstruct the spectral characteristics for the samples in that particular class. The expected result of training is that data associated with spectra for samples outside the particular class will reconstruct less accurately by the specialized AI model.

FIG. 1 further illustrates how third party, counterfeit or competitive taggant systems may exist that inadvertently or purposely could mimic the authentic taggant systems 12, 14, and 16. In some modes of practice, a purpose of the present invention is to provide AI strategies that allow samples whose classification is unknown to be evaluated and accurately classified as authentic (e.g., evaluation shows that the subject matter produces a spectral signature within an authentic class T1, T2, or T3) or is a third party, competitive product or is a fake (e.g., a spectral signature is not present or, if present, does not fit within an authorized class). For purposes of illustration, the third party taggant systems include taggant systems 18 (associated with class Ta), 20 (associated with class Tb), and 22 (associated with class Tc). Each of the different third party, taggant systems 18, 20, and 22 exhibit spectral characteristics in the forms of spectra 19, 21, and 23, respectively. Each of these spectra 19, 21, and 23, in turn, are associated with a corresponding, unique spectral signature that may be intended to be distinguishable from the T1, T2, or T3 classes such as if a legitimate competitor intends to uniquely mark its own products or alternatively that may be intended to improperly fake the T1, T2, or T3 classes such as if a counterfeiter is attempting to distribute counterfeit products.

FIG. 2a schematically shows a marketplace 24 in which taggant library 10 can be deployed on an authentic product line 25 including one or more products and/or services. For or purposes of illustration, product line 25 includes authentic products 26, 28, and 30. Specifically, taggant systems 12, 14, and 16 are deployed on authentic products 26, 28, and 30, respectively, so that each product 26, 28, and 30 is associated with its own, unique spectral signature in this illustrative context. In other modes of practice, an authentic taggant signature, and hence its unique spectral signature, may be properly associated with a plurality of different products rather than just a single product.

FIG. 2a also shows how the third party taggant systems 18, 20, and 22 are respectively deployed on competitive and/or counterfeit products 32, 34, and 36 in marketplace 24. FIG. 2a also shows a competitive or counterfeit product 38 in the marketplace that does not include any taggant system. The present invention allows such tagged and untagged items to be identified as being outside the class or classes associated with the one or more, trained AI models being used for classification.

In practice, the classification or authenticity of an unknown product in marketplace 24 may be at issue. Accordingly, there may be a need to determine if the unknown product in marketplace 24 is one of the authentic products 26, 28, or 30 or is an alternative product 32, 34, 26, or 38. In the practice of the present invention, the product is evaluated to determine if one of the spectral signatures for one of the authentic taggant systems 12, 14, or 16 is present. If present, the product can be confirmed as authentic and classified into the applicable T1, T2, or T3 class. If a proper signature is not present, the product can be confirmed as being outside an authentic T1, T2, or T3 class, indicating the product is from another competitor, was previously unknown or is counterfeit, as the case may be.

In short, the principles of the present invention allow the spectral signatures from the authentic taggant systems 12, 14, and 16 to be read and identified as belonging to the applicable T1, T2, or T3 classes and thereby distinguished from the taggant signatures read from the third party taggant systems 18, 20, and 22, as well as from the absence of a taggant signature on the untagged, third party product 38. This in turn allows the authenticity of products 26, 28, and 30 to be identified, classified, and/or distinguished from the third-party products 32, 34, 36, and 38.

FIG. 2b schematically shows an alternative embodiment of a system 400 of the present invention in which consumable items 402, 404, and 406 are supplied as at least a portion of a feed to processing system 408. Processing system 408 transforms a feed including at least consumable item such as item 402, 404, or 406, as appropriate, into a product 410. For purposes of illustration, Consumable item 402 is marked with authentic taggant system 403, consumable item 404 is marked with fake taggant system 405, and consumable item 406 is untagged. FIG. 2b shows how processing system 408 functions with respect to each type of consumable item in configurations 411, 413, and 415, respectively.

The principles illustrated in FIG. 2b may be practiced with respect to a wide variety of packaged/podded consumable items. Examples include ink cartridges used in home or commercial printers, fabrics, reactants, catalysts or other facilitating ingredients, soap pods used in appliances such as clothes washers or dishwashers, beverage pods of the type used in brewing machines such as the Nespresso, Keurig, and Tassimo branded brewers, soaps, lotions, medicines, diagnostic test strips/cartridges, paints and other coatings, building materials, automotive equipment, industrial lubricants and other chemicals, and the like. The principles illustrated in FIG. 2b may be practiced with respect to a wide variety of other items, such as a taggant, currency, identification cards, gemstones (e.g., diamonds, pearls, etc.), machines having acoustic signatures, and the like.

As shown in configuration 411, processing system 408 includes feed port 412 by which consumable item 402 is fed to the system 408. Optionally, this may be done in combination with one or more other feed components (not shown) introduced to processing system 408 via the same or different feed path. Processing system 408 includes a detector 414 provided proximal to the feed port 412 in a manner effective to read the spectral signature, if any, from the loaded consumable item 402. A controller 416 communicates with detector 414 via communication pathway 420. Detector 414 transmits detected spectral information to controller 416 via communication pathway. In one mode of practice, controller 416 may including programming instructions that use an AI model of the present invention in order to determine that taggant system 403 is authentic. In other modes of practice, controller 416 may communicate with the cloud 428 via communication pathway 424 to determine if taggant system 403 is authentic. In this case, the corresponding AI model may be resident in the cloud 428. When taggant system 403 is confirmed as authentic, controller 416 and/or cloud 428 send control signals to processing components 418 via communication pathways 422 and 426, as the case may be. In response to these control signals, processing components 418 carry out processing in one or more stages in order to convert the consumable 402 into the product 410. Consumable 402 is supplied to processing components 418 by supply line 421. Product 410 is provided from outlet 423.

Desirably, a suitable interface is provided to allow communication between a user and processing system 408. A suitable interface can be provided in any suitable fashion. As illustrated, smart device 430 communicates with processing system 408 via one or more of communication pathways 422, 424, 426, and/or 432. A suitable interface can be provided by other types of devices, including tablets, laptops, and the like. FIG. 2a shows communications with smart device 430 as occurring through cloud 428, but communications also may occur directly between smart device 430 and processing device 408. Any of the communication pathways 422, 424, 426, and/or 432 may be wired or wireless. The communication pathways 422, 424, 426, and/or 432 are multi-directional so that information can proceed in any direction between linked components.

Configuration 413 shows how processing system 408 functions differently when consumable item 404 with counterfeit taggant 405 is fed to processing system 408. In this case, detector 414 reads the spectral signature from taggant system 405. The detected information is sent to controller 416. Program instructions in controller 416 cause an AI model stored in a memory of controller 416 to evaluate if the spectral signature 405 is authentic. In this case, the reconstruction error resulting by using the AI model leads to a determination that the taggant system 405 is a counterfeit taggant system. Consequently, output information is transmitted to smart device 430 via cloud 428 to indicate the detection of the counterfeit item. Output information can be harvested in a variety of other ways as well. For example, output information could be collected in the cloud from multiple devices for later access or archival storage. If a counterfeit is detected, no control signals are sent to actuate processing components 418 to carry out processing of item 404. Instead, the system 408 may be configured to reject item 404. In other embodiments, system 408 through the interface provided by smart device 430 may seek instructions from a user as to what steps to carry out next. For example, if it is known that the item 404 is compatible with processing system 408, the user may input directions to carry out processing of item 404 by a suitable process recipe.

Configuration 415 is the same as configuration 413 except that item 406 is untagged. By using the appropriate AI model, controller 416 can determine this using the information detected by detector 414. As was the case with configuration 413, the interface provided by smart device 430 may seek instructions from a user as to what steps to carry out next. For example, if it is known that the item 404 is compatible with processing system 408, the user may input directions to carry out processing of item 404 by a suitable process recipe.

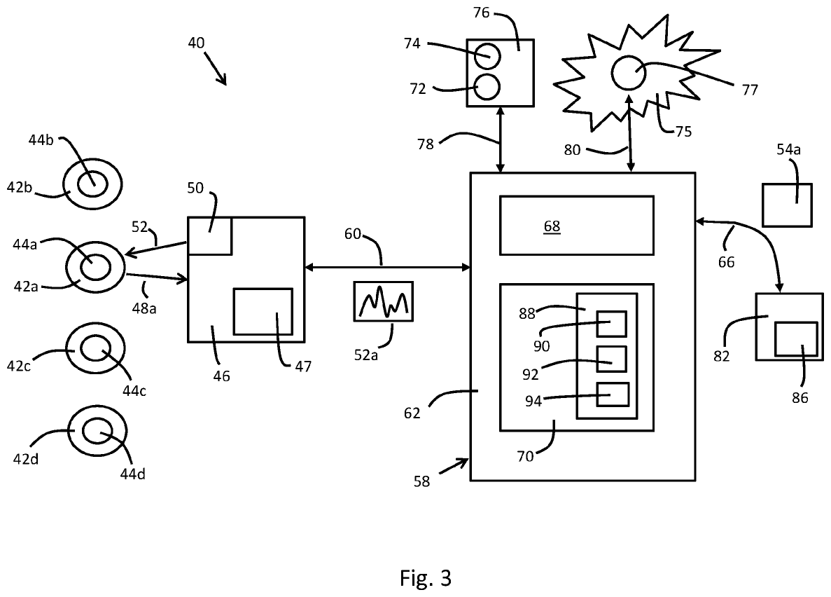

FIG. 3 schematically illustrates a system 40 of the present invention that is useful to evaluate and classify samples to determine, for example, which might be authentic, if any, or which might be competitive products, if any, or which might be counterfeit, if any. At the outset, each sample 42a, 42b, 42c, and 42d is an unknown product bearing an unknown taggant system 44a, 44b, 44c, and 44d, respectively, whose class is unknown. System 40 is configured to read the associated spectral signatures and use information comprising these readings to classify the samples 42a, 42b, 42c, and 42d into one of the T1, T2, or T3 classes (see FIGS. 1 and 2) if appropriate, and thereby confirm identity and authenticity. Otherwise, system 40 is configured to determine whether one or more of the samples 42a, 42b, 42c, and 42d does not fit into any of the T1, T2, or T3 classes to indicate a competitive product or a counterfeit, as the case may be.

As an aspect of such an evaluation, system 40 evaluates if the spectral signature provided by each taggant system 44a, 44b, 44c, and 44d is one of the proper spectral signatures associated with taggant systems 12 (T1), 14 (T2), and 16 (T3). Because an authentic taggant system 12, 14, or 16 may be difficult to reverse engineer and match accurately, the presence of an authentic taggant system exhibiting the proper spectral signature indicates class and authenticity. System 40 can identify and classify the spectral signatures of taggant systems 44a, 44b, 44c, and 44d with high accuracy and resolution. This means that system 40 can detect fake spectral signatures even if the fakes are highly similar to the authentic signatures. The result is that the present invention allows accurate classification to occur with less vulnerability to the skewed normalization problem. In some modes of practice, classification with an accuracy of 95% or higher has been achieved, which is far greater than an 80% accuracy that has been experienced with some modes of practicing probabilistic classification.

In some modes of practice, if a sample provides an evaluation result that is close to a specification or other boundary that is used to define authentic samples, system 40 can generate a warning or other suitable signal that indicates that a sample is close to the boundary and that further follow up is warranted. The signal provided by system 40 can be indicative of how close the unknown sample is to the boundary, For example, a yellow, orange, or red signal could indicate, respectively, a sample that is close (e.g., a reconstruction error from within from greater than 10% to 20% of the boundary), very close (e.g., a reconstruction error within from greater than 5% to 10% of the boundary), or extremely close (e.g., a reconstruction error within 5% of the boundary). Multiple warning levels can be useful in a variety of situations such as to indicate an authentic item is changing, a counterfeit is getting close to an authentic time, or the like.

As shown in FIG. 3, the illustrative embodiment of system 40 includes a reader 46 (also known in the taggant industry as a detector) that is used to read or detect the spectral characteristics of the taggant systems 44a, 44b, 44c, and 44d, respectively, affixed to samples 42a, 42b, 42c, and 42d, respectively. For purposes of illustration, reader 46 is reading the spectral characteristics 48a of taggant system 44a on sample 42a. Spectral characteristics of the other samples 42b, 42c, and 42d are read in a similar way.

In some modes of practice, reader 46 may be an imaging device, a spectrometer, an imaging spectrometer, or other optical or spectroscopic capture device. For purposes of illustration, reader 46 is in the form of a spectrometer designed to capture optical characteristics in the form of spectra emitted by the taggant systems 44a, 44b, 44c, and 44d affixed to samples 42a, 42b, 42c, and 42d in response to -illumination 52. In alternative embodiments, reader 46 may be configured to illuminate and capture optical characteristics of multiple samples at the same time.

In illustrative embodiments, reader 46 captures the spectrum of a sample over one or more wavelength bands of the electromagnetic spectrum. Often, spectral characteristics are captured over one or more wavelength bands in a range from about 10 nm to about 2500 nm, preferably about 200 nm to about 1200 nm, more preferably about 380 nm to about 1000 nm. Such ranges encompass ultraviolet light (about 10 nm to about 380 nm), visible light (about 380 nm to about 700 nm), and infrared light (about 700 nm to about 2500 nm). Spectral capture can be based on one or more of luminescent emission, reflectance, absorption, transmittance, or the like. For purposes of illustration, each taggant system 44a, 44b, 44c, and 44d includes one or more luminescent taggant compounds (not shown). Suitable illumination 52 triggers the corresponding optical characteristics in the form of a luminescent emission whose spectral characteristics are associated with a corresponding spectral signature.

Reader 46 includes an illumination source 50 that provides illumination 52 to trigger the emission of the optical characteristics 48a. Reader 46 reads or detects the optical characteristics 48a and provides an associated input dataset 52a that comprises information that characterizes the optical characteristics 48a. Similar illumination, detection, and input dataset would occur, in turn, for the other taggant systems 44b, 44c, and 44d. Reader 46 includes a user interface 47 by which a user can input instructions or information into reader 46. The user interface 47 also may output information or instructions to a user (not shown).

Desirably, the one or more illumination wavelengths provided by illumination source 50 are from one or more wavelength bands that are different from the one or more wavelength bands that are to be captured or read by reader 46. This is done so that the illumination 52 is distinct from the captured optical characteristics 48a that incorporate the associated spectral signature. If the wavelengths of the illumination 52 overlapped with spectral signature wavelengths associated with the spectral signature, the reading of the proper signature information could be inaccurate at the overlapping wavelengths. For example, if reader 46 is intended to capture spectral signature information for a spectral signature associated with one or more portions of the visible light band over a wavelength range from 420 nm to about 700 nm, then the illumination source 50 may be configured to emit illumination 52 in one or more portions of a wavelength band from 350 nm to about 400 nm. An LED light source that emits light at 380 nm is an example of a suitable light source in such a context.

Computer network system 58 includes reader 46 and at least one computer 62. Reader 46 and computer 62 are shown as two different hardware components of network 58, but in alternative embodiments, reader 46 and computer 62 may be integrated into a single hardware unit. As shown, computer 62 includes at least one hardware processor 68 and at least one memory 70. Computer network system 58 optionally may include one or more additional processor resources 72 and/or memory resources 74 incorporated into one or more other computer devices such as remote computer 76. One or more constituents of computer network system 58 may be cloud-based. For example, network 58 also includes an optional, additional cloud-based memory 77 in cloud 75.

Computer network system 58 includes at least one interface by which a user can interact with computer network system 58. For example, computer network system 58 includes a first output interface 82 associated with computer 62. Reader 46 also includes a further user interface 47. In some embodiments, either interface 82 or 47 may include one or more of a display monitor or screen that optionally is touch sensitive (not shown), keyboard (not shown), mouse (not shown), microphone (not shown), and/or speakers (not shown). For purposes of illustration, user interface 82 displays results 86.

Computer network system 58 includes suitable communication pathways to provide communication interconnectivity among network constituents. For example, computer 68 sends and receives communications to and from the reader 46 via communication pathway 60. Computer network system 58 also may send and receive information to and from at least one output interface 82 via communication pathway 66. Computers 62 and 76 are connected by a communication pathway 78. Cloud-based memory 75 is coupled to computer 68 by communication pathway 80. The communication pathways among the network constituents may be wired or wireless. Connectivity may occur through the internet/cloud.

Computer network system 58 includes artificial neural network system 88. Artificial neural network system 88 incorporates functionality to evaluate and classify samples 42a, 42b, 42c, and 42d to determine if one or more might be within the classes T1, T2, or T3 or if one or more might be outside these classes.

In practical effect, these strategies allow each sample 42a, 42b, 42c, and 42d to be self-authenticating. Artificial neural network system 88 allows the samples 42a, 42b, 42c, and 42d to be self-authenticating in the sense that characteristics obtained from a particular sample 42a, 42b, 42c, or 42d can be compared with AI-transformed versions of those characteristics in order to determine if the particular sample fits within one of the T1, T2, or T32 classes. From one perspective, each sample 42a, 42b, 42c, and 42d is compared to the reconstructed version of itself to determine its classification. Neither the sample nor the reconstructed sample data needs to be compared to authentic samples or features in order to ascertain if there is a match with an authentic class or not. Hence, the original or authentic data can remain safe and secure. Instead, the features of the unknown sample itself are compared to the reconstructed data to ascertain if there is a match or not. Further, access to the AI models would not give a counterfeiter or other party any indication as to the identity/composition of the authentic target. The transformation applied by an AI model of the present invention yields a match when the sample is a member of the class or classes for which the AI model is specialized.

Using the characteristics of a particular sample as an input dataset, an appropriately trained AI model transforms the input dataset into a reconstructed dataset. Generally, the artificial neural network system 88 includes at least one trained AI model configured to accomplish this transformation. In some modes of practice, when multiple classes are involved, the artificial neural network system 88 includes a plurality of unique, trained models, wherein each model is trained to be specialized with respect to an associated, corresponding class. That is, each model can be independently trained and specialized to minimize the reconstruction error when the model is used to transform an input dataset into a reconstructed dataset for the one, associated class type. The reconstruction error would be much larger when the model is used to transform an input dataset for a sample that is not part of the class associated with the model. For purposes of illustration, FIG. 3 describes modes of practice in which a single AI model is specialized to accurately reconstruct data for a single, corresponding class. A plurality of such specialized AI models is provided to allow accurate classification with respect to a plurality of associated classes, respectively.

In other modes of practice, a single AI model can be specialized to accurately reconstruct data for a plurality of corresponding classes so that samples outside the trained classes would reconstruct with higher reconstruction error outside of a desired error specification. For example, an AI model can be specialized to reconstruct data for at least 2, or even at least 5, or even at least 10 different classes. Such an AI model even could be specialized to accurately reconstruct data for 20 or more classes, or even 50 or more classes, or even 100 or more classes.

The one or more models may be stored in one or more memories of computer network system 58. For example, as shown in FIG. 3, artificial neural network system 88 stored in memory 70 includes trained AI model 90 associated with the T1 class, trained AI model 92 associated with the T2 class, and trained AI model 94 associated with the T3 class. More AI models optionally could be included if system 40 is configured to evaluate one or more further classes. Alternatively, the AI models 90, 92, and/or 94 can be stored in remote memory 74 and/or 77. In some embodiments, the models 90, 92, and/or 94 may reside in multiple memories, including in local memory 70 as well as remote memories 74 and/or 77.

As illustrated, artificial neural network system 88 uses specialized AI models 90 (specialized for the T1 class), 92 (specialized for the T2 class), and 94 (specialized for the T3 class) that are trained to accurately reconstruct input datasets only for the class associated with the particular AI model. For purposes of illustration, Sample 42a currently is under evaluation in FIG. 3. The classification for sample 42a is unknown at the outset. FIG. 3 shows how input dataset 52a associated with sample 42a is processed through each of models 90 (T1), 92 (T2), and 94 (T3) to provide output dataset 54a from which results 86 are derived. With high accuracy, a low reconstruction error within a pre-defined reconstruction error specification will only result when a) the sample 42a is within a particular class and b) the AI model for that class is used to obtain the reconstructed dataset. Samples outside the class associated with the AI model, or the use of other models not associated with the class, will yield a reconstructed dataset with relatively higher reconstruction error.

Similarly, each of models 90, 92, and 94 may be applied to input datasets (not shown) for each of the other samples 42b, 42c, and 42d as well. Each of the other samples 42b, 42c, and 42d could be associated with the class whose AI model provided an output with a suitably low reconstruction error, such as a reconstruction error that satisfies a pre-determined error specification. Further, any of samples 42a, 42b, 42c, and/or 42d could be excluded as belonging to any of the classes if the resultant reconstruction errors for that sample were too high with respect to all of AI models 90, 92, and 94.

For example, if Sample 42a were to be in the T1 class, then it would be expected that the reconstruction error associated with output dataset 52a would be the lowest, preferably sufficiently low to be within an applicable reconstruction error specification, when using the AI model 90 corresponding to the T1 class. In other words, the relatively low reconstruction error resulting when using AI model 90 indicates that the taggant system 44a of sample 42a is in the T1 class. Conversely, the reconstruction errors of that very same input dataset 52a would be expected to be relatively higher, and desirably outside of the reconstruction error specification, when using AI model 92 or 94 The reconstruction errors for AI models 92 and 94 would be relatively higher in as much as each of the AI models 92 and 94 is specialized for the T2 and T3 classes, respectively.

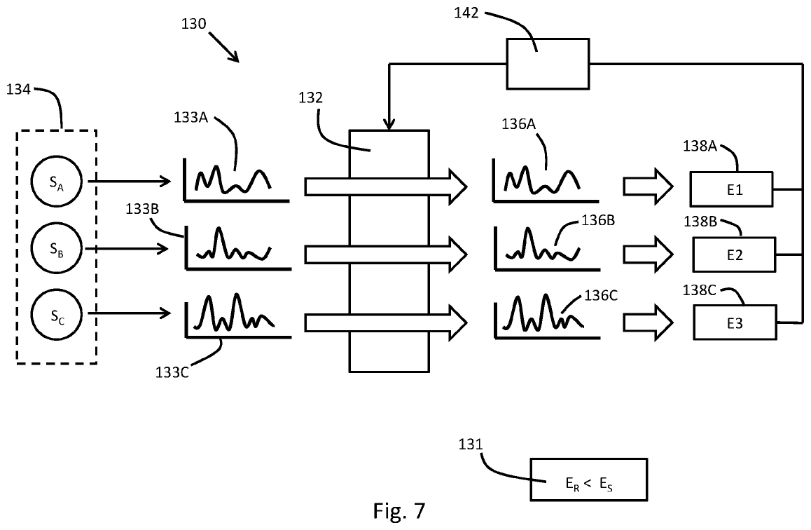

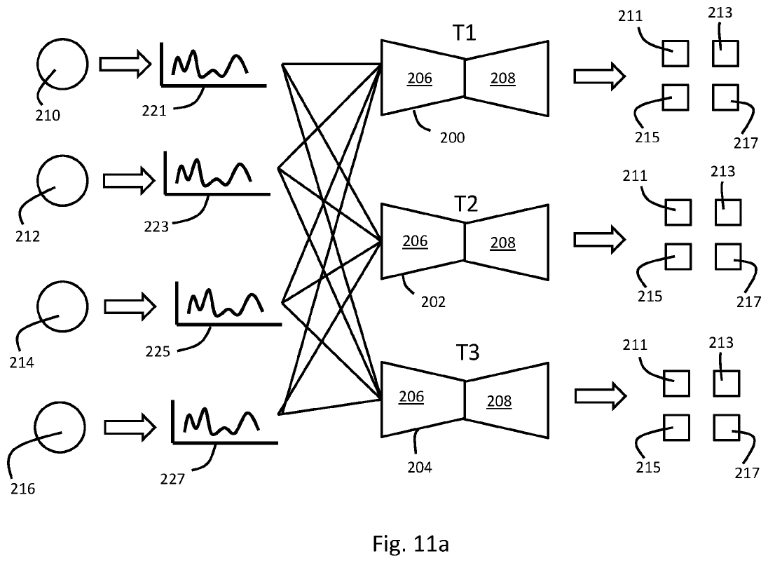

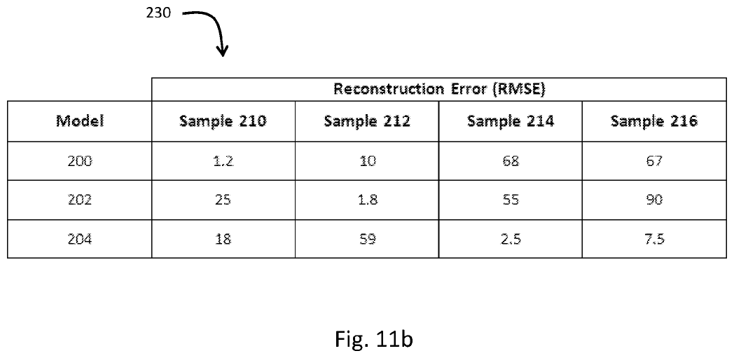

Prior to deployment for real world evaluation, desirably each model 90, 92, and 94 is trained until the reconstruction error for the associated class can be accomplished within a desired reconstruction error specification. Desirably, the reconstruction error specification is set at a level that balances the risk of being too open against being too restrictive. If the reconstruction error specification is too open, this tends to increase the risk of a false positive (a fake is identified as authentic). If the reconstruction error specification is too narrow, this tends to increase the risk that an authentic item could be excluded and classified as a fake (a false negative). The training and resultant specialization of AI models 90, 92, and 94 of FIG. 3 are described further below with respect to FIG. 7. The use of the models to classify samples whose classification is unknown is described further below with respect to FIGS. 11a and 11b.

In a perfect example with no error, the reconstructed dataset 54a would perfectly match the input dataset 52a such that there would be no differences between the corresponding values in reconstructed dataset 54a and the input dataset 52a. In actual practice, however, the output values in a reconstruction dataset typically do not perfectly match to the corresponding values in the input dataset. Hence, some differences will tend to exist between the corresponding values in the reconstruction dataset and the input dataset. These differences can be used to provide the reconstruction error characteristics associated with the data reconstruction. One goal is to train and AI model until the reconstruction errors for authentic samples is sufficiently low to meet a desired error specification. In other words, the particular AI model associated with a particular taggant system is trained to reconstruct authentic training samples for that particular taggant system with low reconstruction error within the desired error specification. The result is that only authentic samples bearing the same taggant system can yield a low reconstruction error within the error specification when an input dataset for that taggant system is transformed by the associated AI model trained. In contrast, the reconstruction errors for other samples, such as those that incorporate a different taggant system or that might be counterfeits with imperfect, faked taggant systems will be higher and outside the error specification.

The error specification can be any value, value range, profile (e.g., equation or graph), or the like that characterizes the difference(s) between the input dataset 52a and the reconstructed dataset 54a. For example, consider the illustrative example introduced above in which input dataset 52a includes 1200 data values Xⱼ, where j is 1 to 1200 and in which the output dataset 54a includes 1200 data values Yj, where j is 1 to 1200. Each corresponding data pair Xj and Yj may be characterized by an expression that indicates how the two values compare. For instance, each comparison may be computed as a difference (Yⱼ−Yⱼ), a ratio Yⱼ/Xⱼ, or the like. The result is an array of comparison values. In this illustration, with 1200 values in each of the input dataset 52a and 1200 values in the output dataset 54a, the comparison array has 1200 values.

In the practice of the present inventions reconstruction error characteristics may be derived from the array of comparison values in variety of different ways. According to one mode of practice, the comparison values may be graphed with the value of the comparison values on the y-axis and the sample number j on the x-axis. The reconstruction error characteristics can be given by the resultant profile. The corresponding reconstruction error specification may be set so that at least 50%, or even at least 80%, or even at least 90%, or even at least 95%, or even at least 99%, or even 100% of the comparison values of all the values or one or more selected ranges of the values are below a threshold value.

In an alternative aspect of providing a reconstruction error specification for such a profile, multiple criteria may be used. For example, the error specification may be set so that all of the comparison values or one or more selected portions of the values are lower than a specified first threshold value and so that at least 50% or even at least 80% or even at least 90% or even at least 95% or even at least 99% of the comparison values are below a second threshold value, wherein the second threshold value is less than the first threshold value. Using multiple thresholds is another way to determine if an authentic target is changing or if counterfeit samples are getting closer to matching the authentic target. For example, if reconstruction error for an authentic target is increasing relative to the first or second threshold values as compared to historical results for that target, a change, degradation, or other modification of the authentic target would be indicated. Comparison to the thresholds can indicate a closer match. Furthermore, if a close counterfeit sample is detected, a separate reconstruction model can be built for the close counterfeit samples to more accurately separate them from the authentic target.

In other modes of practice, a single reconstruction error value may be derived from the array of comparison values, and then an error specification can be based on such a derived reconstruction error. For example, the comparison values, or the square of the comparison values, or the square root of the square of the comparison values can be summed and then divided by the number of values in the comparison value array. The resultant derived value can be deemed to be the reconstruction error for the array of comparison values. When the actual comparison values are summed and divided by the number of data pairs, the resultant computation provides an average comparison value as the reconstruction error. When the squares of the comparison values are summed and divided by the number of data pairs, the resultant computation provides the mean square error (MSE) as the reconstruction error. When the squares are summed and the sum is divided by the number of data pairs, and then the square root of this division is obtained, the resultant computation provides a root mean square error (RMSE) as the reconstruction error. The error specification can then be expressed as a requirement that a sample must have such a computed reconstruction error that is below a specified threshold in order for the sample to be within the class corresponding to the AI model being used.

The AI model can be trained until it is able to provide reconstructions for the corresponding class that meet a desired threshold. Alternatively, the AI model can be trained using one or more training samples (e.g., at least 1, or even at least 10, or even at least 50 training samples and as many as at least 100, or even at least 300, or even at least 1000 training samples) through at least one, or even at least two, or even at least 5, or even at least 10 training cycles.

In other modes of practice, the reconstruction error may be based on Euclidean distance (i.e., the square root of the squares that are summed), and the error specification may be given by an appropriate Euclidean distance boundary.

In some modes of practice, the data values in the input and reconstruction datasets can be expressed as a moving average over successive intervals, and then the comparison values can be derived from these moving average values. For example, for illustrative purposes, the following Table 1 shows how the input and reconstruction values using an AI model may be collected at wavelength intervals of 2 nm for 100 training samples associated with a particular class. The average intensity values at each wavelength is reported in the input and reconstructed value columns. Moving averages of the input and reconstructed values over, for example, three intervals are determined. Other intervals may be used such as from 2 to 30 intervals. The corresponding moving average values between corresponding pairs of input and reconstruction moving average values may then be compared. In this case, these comparison values are expressed as corresponding RMSE values, respectively. In one mode of practice, the overall reconstruction error for all the values may be calculated as the average of the RMSE values. In this case, the reconstruction error would be 0.39. This may be set as the reconstruction error specification that needs to be satisfied for a sample to be classified in the particular class.

Alternatively, the reconstruction error specification may be the average of the RMSE values plus a safety factor to help reduce the risk of false negatives. At the same time, the safety factor should not be unduly large to help reduce the risk of false positives. In some embodiments, the safety factor may be computed in different ways such as by being a multiple of the standard deviation of the RMSE values, e.g., from 0.5 to 2.5, preferably 0.5 to 1.5 times the standard deviation. For example, the standard deviation of the RMSE values in Table 1 is 0.25. If the safety factor is set as 0.5 times this value, then the reconstruction error specification would be given as 0.52 (calculated from R=0.39+[0.5×0.52], wherein R is the reconstruction error specification).

Alternatively, the RMSE values may be expressed as a percentage of the corresponding input moving average value. The reconstruction error may be specified as an average of the RMSE values expressed as a percentage. In this case the reconstruction error expressed in this fashion would be 1.63%. This value could be the reconstruction error specification expressed as a percentage. With a safety factor of 1 standard deviation (1.46), the resultant reconstruction error would be 3.9%.

Table 1 shows a table of hypothetical reconstruction error values can be derived from a hypothetical input dataset for a sample. In practice the input dataset may be provided over one or more portions of the electromagnetic spectrum or other suitable input spectrum, e.g., sound, NMR, electrocardiogram (ECG, EKG), etc. For example, data could be collected over a wavelength range of 400 nm to 1200 nm in some embodiments at wavelength intervals from 0.1 nm to 10 nm, preferably 0.5 nm to 5 nm, more preferably, 1 nm to 2 nm. For purposes of illustration, the input dataset is obtained over a wavelength range from 420 nm to 484 nm at intervals of 2 nm. Table 1 shows corresponding reconstructed values are obtained from the input dataset using an AI model of the present invention. Moving averages of the input data values and the reconstructed data values are determined. The difference between each reconstructed value and the corresponding input data value is determined.

The resultant differences can be used in a variety of ways to determine the reconstruction error characteristics of the sample. According to one technique, the table of differences can be used to derive a single reconstruction error value. For example, the table of differences can be used to determine a single MSE, RMSE, or Euclidean distance to characterize the reconstruction error for the sample. According to another technique the listing of differences can be plotted as a function of wavelength. This provides a reconstruction error profile by which to characterize the sample. One or more thresholds can be used to assess if the profile characterizes an authentic sample or not. Characterizing the reconstruction error as a profile may be advantageous when a marketplace is burdened by one or more counterfeits that are a close match with an authentic target. A reconstruction error profile, much like a fingerprint, has many different details to match successfully.

TABLE 1
Reconstruction error for sample input dataset
over a wavelength range from 420 nm to 484 nm:

| | | | Input | Reconstruction | | |
|---|---|---|---|---|---|---|
| | | | value moving | value moving | | Difference |
| Wavelength | Input | Reconstructed | average over | average over | | expressed |
| (nm) | value | Value | 3 intervals | 3 intervals | Difference | as a % |
| 420 | 15.05 | 15.95 | | | | |
| 422 | 16.7 | 17 | | | | |
| 424 | 35.02 | 34.72 | 22.26 | 22.56 | 0.30 | 0.86 |
| 426 | 75 | 75.9 | 42.24 | 42.54 | 0.30 | 0.40 |
| 428 | 79.63 | 79.51 | 63.22 | 63.38 | 0.16 | 0.20 |
| 430 | 51.5 | 51.23 | 68.71 | 68.88 | 0.17 | 0.33 |
| 432 | 22.98 | 23.28 | 51.37 | 51.34 | 0.03 | 0.13 |
| 434 | 25.65 | 27.15 | 33.38 | 33.89 | 0.51 | 1.99 |
| 436 | 39.79 | 39.19 | 29.47 | 29.87 | 0.40 | 1.01 |
| 438 | 38.12 | 38.72 | 34.52 | 35.02 | 0.50 | 1.31 |
| 440 | 12.65 | 13.55 | 30.19 | 30.49 | 0.30 | 2.37 |
| 442 | 8.88 | 8.88 | 19.88 | 20.38 | 0.50 | 5.63 |
| 444 | 22.97 | 23.27 | 14.83 | 15.23 | 0.40 | 1.74 |
| 446 | 30.35 | 28.25 | 20.73 | 20.13 | 0.60 | 1.98 |
| 448 | 38.68 | 37.78 | 30.67 | 29.77 | 0.90 | 2.33 |
| 450 | 76.52 | 76.82 | 48.52 | 47.62 | 0.90 | 1.18 |
| 452 | 75.32 | 75.92 | 63.51 | 63.51 | 0.00 | 0.00 |
| 454 | 35.92 | 35.32 | 62.59 | 62.69 | 0.10 | 0.28 |
| 456 | 29.77 | 30.97 | 47.00 | 47.40 | 0.40 | 1.34 |
| 458 | 15.81 | 17.61 | 27.17 | 27.97 | 0.80 | 5.06 |
| 460 | 16.44 | 15.24 | 20.67 | 21.27 | 0.60 | 3.65 |
| 462 | 22.49 | 24.59 | 18.25 | 19.15 | 0.90 | 4.00 |
| 464 | 33.27 | 32.67 | 24.07 | 24.17 | 0.10 | 0.30 |
| 466 | 66.31 | 66.01 | 40.69 | 41.09 | 0.40 | 0.60 |
| 468 | 76.73 | 77.33 | 58.77 | 58.67 | 0.10 | 0.13 |
| 470 | 70.55 | 71.45 | 71.20 | 71.60 | 0.40 | 0.57 |
| 472 | 43.46 | 43.46 | 63.58 | 64.08 | 0.50 | 1.15 |
| 474 | 17.29 | 17.59 | 43.77 | 44.17 | 0.40 | 2.31 |
| 476 | 15.88 | 16.78 | 25.54 | 25.94 | 0.40 | 2.52 |
| 478 | 11.53 | 11.53 | 14.90 | 15.30 | 0.40 | 3.47 |
| 480 | 20.11 | 20.71 | 15.84 | 16.34 | 0.50 | 2.49 |
| 482 | 18.79 | 18.49 | 16.81 | 16.91 | 0.10 | 0.53 |
| 484 | 15.38 | 14.78 | 18.09 | 17.99 | 0.10 | 0.65 |

As a result of training an AI model, it can be expected that reconstruction errors computed in the same manner for non-authentic samples would be expected to be greater than the error specification derived from the authentic samples that are within the class corresponding to the trained AI model. Consequently, if a reconstruction error is within the error specification, then the sample can be confirmed as authentic. If the reconstruction error is outside the error specification, then the sample can be confirmed as being outside the class associated with the AI model. If the error is near the error specification but just above or just below, the sample can be flagged as a potential counterfeit sample. Alternatively, this can indicate information such as that samples are drifting and/or that models need to be updated in the system to account for signature changes.

Still referring to FIG. 3, after training is completed and the AI models 90, 92, and 94 used to evaluate samples such as samples 42a, 42b, 42c, and 42d in actual use, the results of those evaluations may be used to update the training of the AI models 90, 92, and/or 94 and/or the corresponding error specifications. The updated model parameters and/or error specification details may be computed remotely in a secure location, and then the update instructions can be transmitted to user devices such as computer devices 62 or 76, wherein the updated instructions can be downloaded and installed in the applicable software.

A distinct advantage of the present invention is that the analysis discussed with respect to FIG. 3 is accurate, repeatable, and sensitive to even tiny differences between authentic characteristics and those of fakes. Consequently, error specifications can be set with tight tolerances with a relatively low risk of excluding authentic items from a determination of authenticity while also reducing the risk of false positives of authenticity with respect to fake subject matter. Moreover, the ability to update the AI models 90, 92, and 94 in real time allows the performance of the models to be serviced, maintained, and/or improved over time.

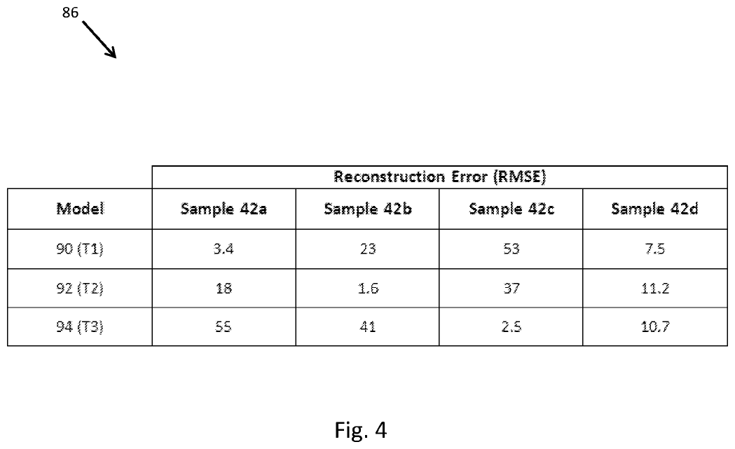

FIG. 4 schematically shows exemplary results 86 of FIG. 3 in more detail. Results 86 show illustrative data that might result when applying models 90, 92, and 94 to each of samples 42a, 42b, 42c, and 42d, respectively. Results 86 as shown in FIG. 4 are in the form of a table in which each reconstruction error is expressed as a RMSE value. The reconstruction errors are shown for each sample as a function of the model applied to the input dataset for that sample. Assuming for purposes of illustration that each of the models 90, 92, and 94 is trained to recognize a sample within the associated class according to a reconstruction error (RMSE) of less than 4.5, the results show that sample 42a is in class T1, sample 42b is in class T2, and sample 42c is in class T3. This is shown by the fact that the reconstruction error is only within the error specification for these matches, respectively. In the meantime, the reconstruction error for sample 42d is outside the reconstruction error when any of models 90, 92, and 94 is applied. This shows that sample 42d is not in any of the T1, T2, or T3 classes. In some contexts, this would indicate that sample 42d is counterfeit. The close proximity of the reconstruction error of sample 42d with respect to each of the T1, T2, and T3 models could indicate that sample 42d attempts to counterfeit sample 42a, yet the AI strategies of the present invention are able to detect this.

The input dataset 52a of FIG. 3 may be used to show how reconstruction errors for a particular sample such as sample 42a, 42b, 42c, or 42d may be provided as a profile. FIG. 3 illustrates a context in which the input dataset 52a includes intensity values for a spectrum as a function of wavelength over a wavelength range of interest that provides the corresponding spectral signature. The reconstructed dataset 54a may include corresponding, reconstructed intensity values as a function of wavelength over the same wavelength range. Comparison values of each corresponding input and reconstruction pair at each wavelength can be computed and then plotted, tabulated, or otherwise characterized as a function of wavelength. The corresponding error specification may then be specified as being a boundary such that at least 50%, or even at least 80%, or even at least 90%, or even at least 95%, or even at least 99% or even 100% of the comparison values are at or below such boundary. Each model 90, 92, and 94 may be trained sufficiently in illustrative modes of practice so that the comparison value for a given proportion or even every corresponding data pair in the input and reconstruction datasets is at and/or below a desired value or boundary.

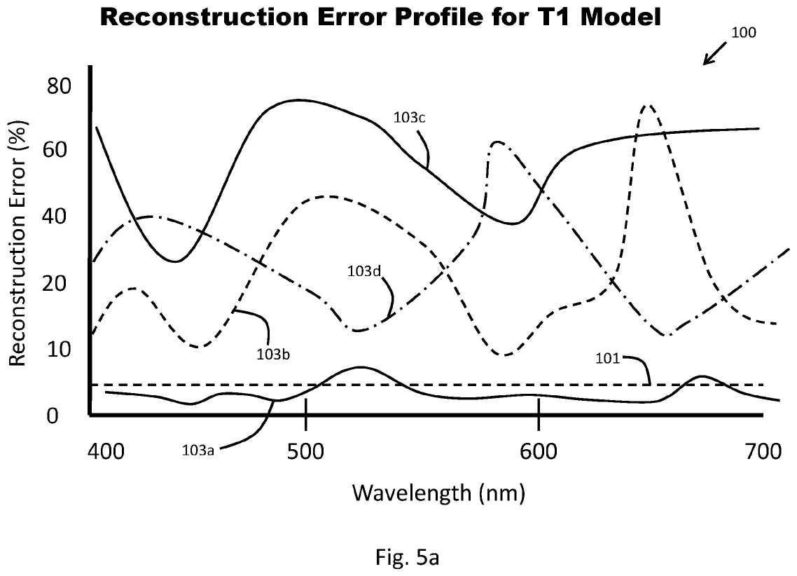

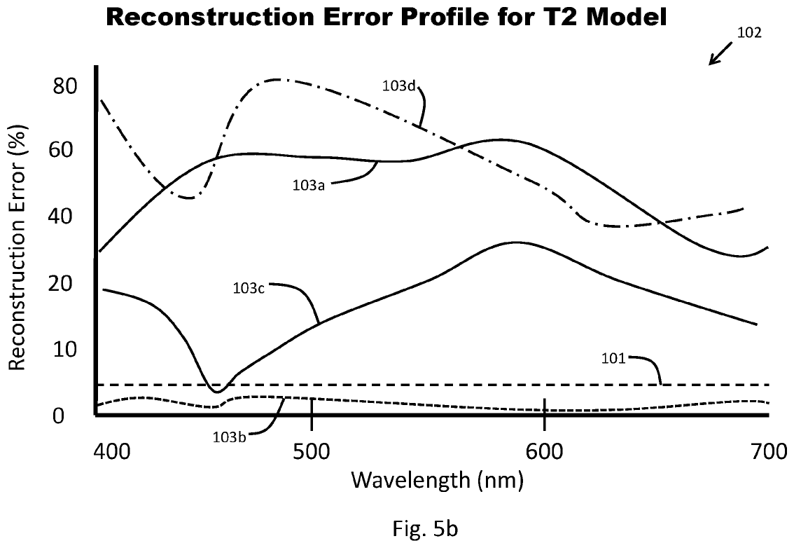

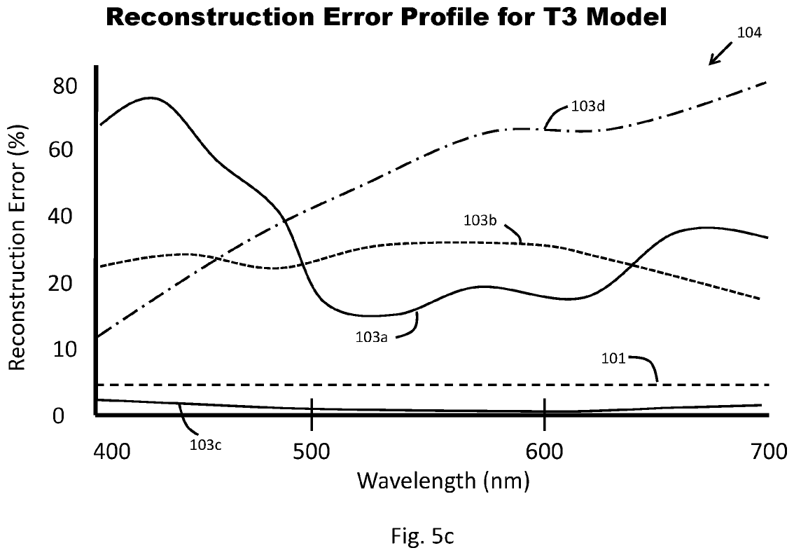

FIGS. 5a, 5b, and 5c schematically show illustrative embodiments of reconstruction error analyses 100, 102, and 104, respectively, which may be used to classify samples 42a, 42b, 42c, and 42d when the comparison values of each sample are plotted as a profile across a wavelength range and wherein the error specification 101 is set as a boundary to encompass a sufficient proportion of the authentic comparison values. In FIGS. 5a, 5b, and 5c, the profile of the comparison values across the wavelength range represents the reconstruction error expressed as a profile. The error specification 101 in each of FIGS. 5a, 5b, and 5c is set at 5% for purposes of illustration, but this specification may be independently set at any value or profile as appropriate for each model being used. For example, another strategy is to set a reconstruction error specification so that a certain percentage (e.g., at least 80%, or even at least 85%, or even at least 90%, or even at least 95%, or even at least 99%, or even 100%) of the training samples are correctly classified by the corresponding AI model. In FIGS. 5a, 5b, and 5c, each profile 103a, 103b, 103c, and 103d of the comparison values across the wavelength range represents the reconstruction error expressed as a profile. Each of FIGS. 5a, 5b, and 5c plots the reconstruction error profiles 103a, 103b, 103c, and 103d, respectively, of each of samples 42a, 42b, 42c, and 42d across the visible wavelength range from 400 nm to 700 nm.

In FIGS. 5a, 5b, and 5c, the reconstruction errors are plotted as profiles for purposes of illustration. In other embodiments, the differences between the reconstructed values and the corresponding input values can be used to derive a single value for the reconstruction error.

In FIG. 5a, only the profile 103a for sample 42a is below the error specification across a majority of the wavelength range. As shown, when considering the wavelength values from 400 nm to 700 nm, only the comparison values from 510 nm to 540 nm and from 675 nm to 690 nm are slightly above the error specification boundary. The profiles 103b, 103c, and 103d are all too large to satisfy the error specification at any wavelength. These results allow sample 42a to be classified into the T1 class according to an error specification that requires 80% or more of the comparison values to be within the error specification boundary. As an alternative, the error specification boundary could be set at a higher percentage value, but then this could increase the risk of capturing samples from other profiles as false positives.

In FIG. 5b, only the profile 103b for sample 42b has at least 80% of its comparison values within the reconstruction error specification. The profiles 103a, 103c, and 103d are all too large to satisfy the error specification, although profile 103c has a small number of comparison values within the error specification boundary for wavelengths from 450 nm to 460 nm. These results allow sample 42b to be classified into the T2 class.

In FIG. 5c, only the profile 103c for sample 42c is within the boundary of the error specification. The profiles 103a, 103b, and 103d are all too large to satisfy the error specification. These results allow sample 42c to be classified into the T3 class. It is noted that the profiles 103d for sample 42d in all the models are all outside the reconstruction error threshold. This shows that sample 42d is not within any of the T1, T2, or T3 classes, although its error profile is closest to the error specification for the T1 model in FIG. 5a. This indicates that sample 42d could be an attempt to counterfeit the authentic sample 42a.

FIGS. 4, 5a, 5b, and 5c show that the transformation of input data by a particular AI model 90, 92, or 94 to obtain corresponding reconstruction data only yields a particular result within the corresponding error specification for a sample of a certain type. In contrast, the same transformation as applied to characteristics for other types of samples yields different results that fail to meet the error specification. For example, counterfeits or imposters, even close ones, produce a vastly different result when transformed by the applicable AI model(s), making the fakes easy to identify.

The fact that classification can be accomplished by comparing characteristics of each sample 42a, 42b, 42c, and 42d to an AI-transformed version of those characteristics provides several advantages. There is no need to ever compare a sample to any original data associated with the actual authentic subject matter used to train the AI model(s) so that the original data can remain safely hidden and secure. Hence, in many modes of practice, the original information is never accessed or used for classification or authentication when the AI strategies of the present invention are applied. Client privacy also is enhanced because access to the original source data is not needed to accomplish classification.

Also significant, verification may be done without accessing a remote database. An internet or network connection while doing authentication, identification, ownership verification, or other evaluation is not required. This means internet or network connections can be lost or unavailable system 40 still works. Since only the authentic sample transforms successfully using the associated AI model, counterfeiter or hacker access to the AI models does not jeopardize the security of the original data or even allow counterfeiters or hackers to implement their trickery more easily.

Referring again to FIG. 3, at least one processor 68 and/or 72 is configured to execute steps that implement the following instructions stored in at least one memory 70 and/or 74. For purposes of illustration, these steps will be described with respect to sample 42a. Similar steps could be performed with respect to samples 42b, 42c, 42d, or any other sample whose classification with respect to the T1, T2, or T3 classes is at issue. First, the instructions cause the hardware processors 68 and/or 72 execute a step comprising receiving receive an input 52a for sample 42a. The instructions further cause the hardware processors 68 and/or 72 to execute a step comprising accessing the artificial neural network system 88, which comprises the AI models 90, 92, and 94. Each of these models independently transforms the input dataset 52a into a corresponding reconstructed dataset 54a. Each model 90, 92, and 94 is uniquely associated with one of the classes T1, T2, or T3, respectively, so that the reconstructed dataset 54a produced by a particular model 90, 92, or 94 matches the input dataset 52a within an associated error specification when sample 42a is in the class associated with the particular model 90, 92, or 94. In many modes of practice, the reconstructed dataset 54a will mismatch the input dataset 52a sufficiently for samples not in the model's associated class so that the reconstruction error is outside the associated error specification for the particular model. Such a mismatch could be the case if the sample 42a is not authentic, e.g., sample 42a is counterfeit, or is the product of a competitor using a different taggant system and hence different taggant signature, or is an alternative product without any taggant system affixed to it.

The instructions cause the hardware processors 68 and/or 72 to execute a step comprising using information comprising at least one AI model 90, 92, and/or 94 to respectively transform information comprising the input dataset 52a into the reconstructed dataset 54a. Desirably, this transformation is performed using each model 90, 92, and 94, respectively, to provide a reconstructed dataset 56a for each model. The instructions cause the hardware processors 68 and/or 72 to execute a step comprising comparing information comprising the input dataset and/or a derivative thereof and the reconstructed dataset and/or a derivative thereof to determine information indicative of a reconstruction error between the input dataset and/or derivative thereof and the reconstruction dataset and/or derivative thereof. The instructions cause the hardware processors 68 and/or 72 to execute a step comprising using information comprising the reconstruction error and/or a derivative thereof to determine information indicative of whether the sample is in the corresponding class.

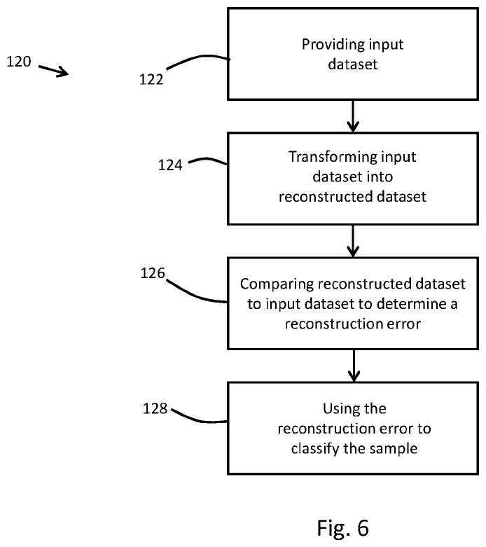

FIG. 6 schematically shows an illustrative method 120 for using System 40 of FIG. 3 to carry out a classification evaluation with respect to a sample such as any of samples 42a, 42b, 42c, and 42d, respectively. In step 122, an input dataset, such as input dataset 52a is provided for a sample. The input data set comprises information indicative of characteristics associated with the sample. In some modes of practice, the information includes optical information harvested from the sample or a component thereof. For example, if the evaluation is undertaken to determine if the sample includes a proper taggant system, the optical information can be the spectral characteristics obtained from the sample. If the sample is a person, biometric data can be harvested from the person by image capture or the like. Other information, such as name, driver's license number, social security number, or other personal information may be used to assist with identity verification.

In step 124, the input dataset is transformed into a reconstructed dataset using an AI model that is associated with a particular class and that is trained so that the reconstruction error characteristics of the reconstructed dataset are within an error specification when the sample is within the particular, associated class. If multiple classes are at issue, then a plurality of such AI models are provided so that each AI model minimizes the reconstruction error for samples in the associated class.

In step 126, the reconstructed dataset is compared to the input dataset. In some modes of practice, derivatives of these are prepared by first modifying (using one or more data modification strategies) and/or manipulating (using one or more data manipulation strategies) and then comparing the reconstructed and input datasets or the derivatives thereof. Modifications and/or manipulations to prepare derivatives can be practiced in order to convert the data into a more useful form. For example, the data can be normalized or otherwise standardized. In other instances, moving averages (and/or other smoothing or compression strategy) and/or percentages can be used. In other instances, data aberrations, filters, incorporating a bias, incorporating a weight, or the like can be addressed by suitable manipulation or modification. Strategies for accomplishing data manipulation or modification are well known. Exemplary examples of such strategies are incorporated into commercially available spreadsheet programs, such as the MICROSOFT EXCEL brand spreadsheet. Generally, data manipulation refers to processing raw data with the use of logic or calculation to get different and more refined data. Data modification refers to changing the existing data values or data itself.

In step 128, information comprising the reconstruction error and/or a derivative thereof is used to determine if the sample is in the class associated with the AI model that was used to prepare the reconstructed dataset. If the reconstruction error and/or derivative thereof is within an error specification, then the sample is deemed to be a part of the associated class. If the reconstruction error and/or derivative thereof is outside the specification, then the sample is outside the associated class.

FIG. 7 schematically illustrates a system 130 in which an AI model 132 of the present invention is trained to minimize reconstruction error with respect to a sample set 134 of training samples from a particular class, T. The goal 131 of the training is to use AI training strategies to train model 132 until the model is able to classify samples with a desired level of accuracy such as if the reconstruction error characteristics obtained from the sample set 134, E_{R}, are less than an error specification, E_{S} and/or if a certain percentage (e.g., at least 80%, or even at least 85%, or even at least 90%, or even at least 95%, or even at least 99%, or even 100%) of the training samples are correctly classified by the AI model.

Sample set 134 comprises one or more training samples that are representative members of the particular class for which AI model 132 is being trained. For example, the training samples may include a particular taggant system associated with a particular class T. The number of training samples including in the sample set 134 may vary over a wide range. In some modes of practice, a single training sample may be used. In other modes of practice, two or more training samples are used. For purposes of illustration, FIG. 7 shows three training samples S_{A}, S_{B}, and S_{C} being used. In other modes of practice, the number of training samples is at least 2, preferably at least 3 as shown, more preferably at least 5, and more preferably at least 10. In some embodiments, the number of training samples may be as large as 10, or even as large as 100, or even as large as 1000 or more.

Input datasets 133_{A}, 133_{B}, and 133_{C} are obtained for each of the samples S_{A}, S_{B}, and S_{C} respectively. Each input dataset 133_{A}, 133_{B}, and 133c comprises information that characterizes the corresponding training sample. For example, each input dataset 133_{A}, 133_{B}, and 133_{C} may comprise spectral characteristics harvested from the corresponding taggant system incorporated into the training samples of sample set 134.

The AI model 132 is then used to transform at least one of the input datasets 133_{A}, 133_{B}, and 133_{C} into one or more corresponding, reconstructed datasets 136_{A}, 136_{B}, and 136_{C}, respectively. Each reconstructed dataset 136_{A}, 136_{B}, and 136_{C} is compared to the corresponding input dataset 133_{A}, 133_{B}, and 133_{C}. Differences between each pair are used determine reconstruction error characteristics 138A, 138B, and 138C, respectively. The reconstruction error characteristics 138A, 138B, and 138C are then used to derive training model changes 142 that are then used to alter the AI training model 132. The methodology of using the updated AI model 132 to transform input datasets to generate reconstructed datasets with reconstruction error characteristics to derive training model changes 142 is repeated until the goal 131 is met or exceeded. In this scenario, the reconstruction error is within the error specification when E_{R}<E_{S}. In each cycle, the same training samples, a portion of those samples, and/or different training samples representative of the class may be used to generate input datasets for that cycle.

Once the goal 131 is satisfied or exceeded, the training results in a trained and specialized AI model 132 that is available to evaluate and classify samples whose classification is unknown. If application of the AI model 132 to a sample results in a reconstruction error E_{R} within the error specification E_{S}, then the sample is classified as being within class T. If the application of the AI model 132 to a sample results in a reconstruction error outside the specification, then the sample is outside class T. Thus, it can be seen that the AI model 132 is trained to accurately reconstruct input data from only one particular class. The methodology may be repeated to train other AI models to specialize to minimize reconstruction error characteristics with respect to other classes.

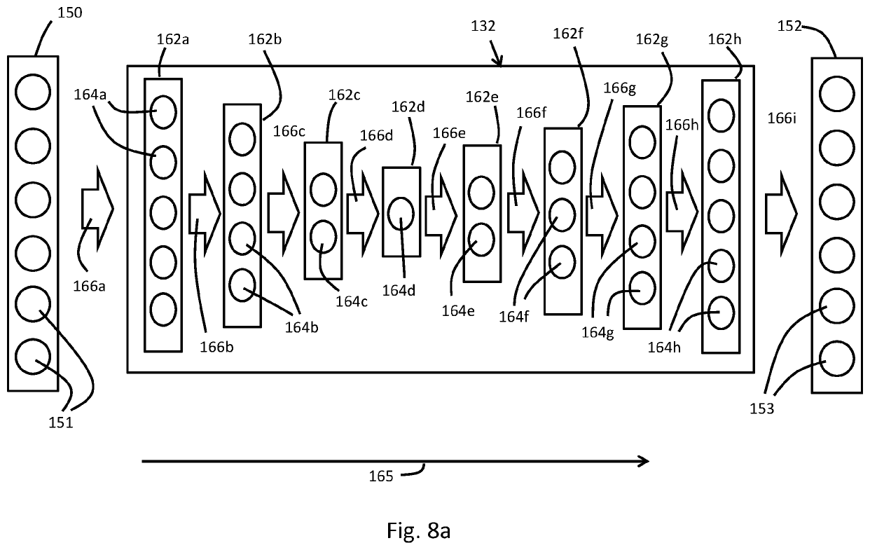

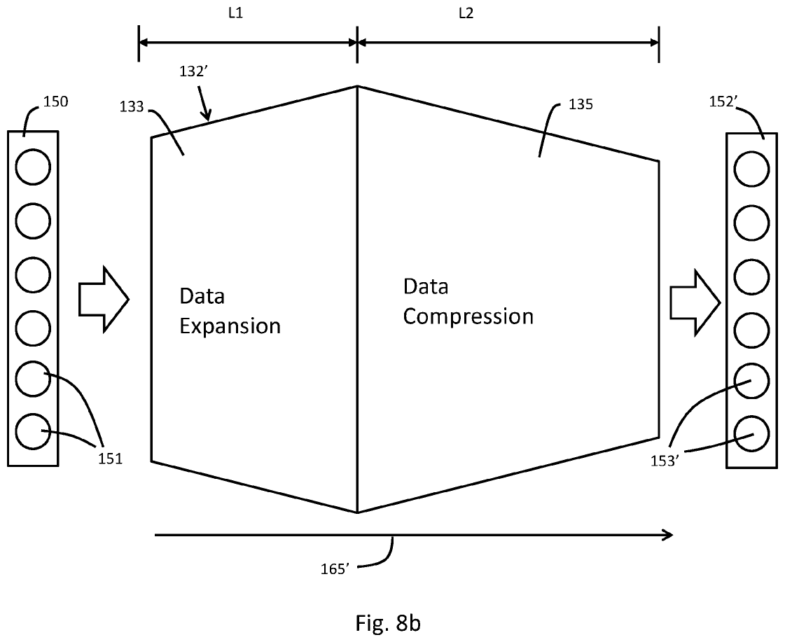

FIG. 8a schematically illustrates how principles of the present invention are incorporated into a preferred architecture of the trained AI model 132 of FIG. 7. In use, trained AI model 132 receives an input dataset 150 obtained from a sample (not shown) and provides a reconstructed dataset 152. Input dataset 150 also includes data values 151, and output dataset 152 includes data values 153. As described above, the reconstruction error (not shown in FIG. 8) that results by comparing the input dataset 150 to the reconstruction dataset 152 can be used to determine if the sample is in the class T.

Generally, AI model 132, also known in the industry as a deep neural network AI model 132 comprises at least one hidden neural network layers (also referred to herein as “hidden layer” or “transformation stages”) that receive the input data and transform the input dataset 150 to provide the reconstructed dataset 152. Generally, using fewer hidden layers may result in a data transformation in which the reconstruction differences might not be as distinguishable as desired as between samples in the class or classes associated with the AI model 132 and samples outside such class or classes. More layers tend to allow the AI model 132 to be more specialized with respect to the associated class or classes so that reconstruction differences more easily distinguish class members from other samples. However, as the number of hidden layers increases, there are practical computing power concerns with respect to training and/or using AI model 132. Additionally, using fewer layers tends to result in faster and less expensive training as well as faster evaluation of samples. Yet, using a greater number of layers provides enhanced specialization capabilities, but would involve much longer and expensive training and slower sample evaluation. The number of training samples needed to effectively train AI model 132 also generally tends to be larger as number of hidden layers increases. Hence, it is desirable to balance resolution against resource limitations. The number and size of the hidden layers also may depend on the size and complexity of the input dataset. Smaller datasets or datasets with lower dimensionality (e.g., fewer variables or wavelengths, etc.) may tend to require fewer hidden layers than a larger dataset or a dataset with higher dimensionality. More complex datasets may tend to require more hidden layers than a less complex dataset.

Generally, in some modes of practice, using only one or two layers would be sufficient. In other modes of practice, using at least 5, or even at least 10, or even at least 100, or even at least 1000, or even at least 10,000 or more layers could be sufficient. In illustrative embodiments, AI model 132 incudes from 2 to 10,000, preferably 2 to 1000, more preferably 5 to 100, or even more preferably 5 to 50 layers.

For example, an AI model with only a single layer could implement principles of the present invention if the single hidden layer either compresses (or shrinks) or decompresses (or expands) the input data layer before applying a transformation to obtain the reconstructed data set. An illustrative embodiment of this type could be an AI model that uses an input computation to compress an input data set of n dimensions to a hidden layer with m dimensions, where m is less than n, and preferably the ratio m:n is in the range from 0.9:1 to 1:100. Then the activation of the hidden layer to a reconstructed dataset of n dimensions (to match the input dataset) would decompress the data. As another example, an AI model that uses an input computation to expand an input data set of n values to a hidden layer with m dimensions, where n is less than m, and preferably the ratio n:m is in the range from 0.9:1 to 1:100. Then the activation of the hidden layer to a reconstructed dataset of n values (to match the input dataset) would compress/shrink the data. In representative embodiments, m could be 5 to 10,000 and n could be 5 to 10,000.

For purposes of illustration, AI model 132 includes eight hidden layers 162a to 162h. This embodiment would provide an AI model that is trainable using reasonable resources and that has excellent specialization capabilities for accurate classification.

According to a preferred aspect of the present invention, AI model 132 is configured so that the data transformation includes at least one compression of data and at least one decompression (or expansion) of data in the transformation stages provided by hidden layers 162a to 162h of the AI model 132. Preferably as shown the transformation involves compressing the data in a plurality of data compression stages and decompressing or expanding the data in a plurality of data decompressing or expansion stages. For example, a data compression occurs when a hidden layer of the AI model 132 has a smaller number of nodes compared to an immediately upstream layer, which may be another hidden layer or the input data layer, as the case may be. Similarly, a data decompression or expansion occurs when a hidden layer or the output layer, as the case may be, has a greater number of nodes compared to an immediately upstream layer, which may be another hidden layer or the input data layer, as the case may be. The compression and decompression/expansion of data may occur in any order. The advantage of compressing and decompressing the data is that this enhances the ability of the AI model 132 to specialize in the reconstruction of data for one or more associated classes. As a consequence of using both data compression and decompression/expansion, the overall transformation becomes so complex and uniquely tailored to the trained, authentic samples such that only authentic samples of the associated class or classes are able to be reconstructed with sufficient accuracy to meet a reconstruction error threshold. The reconstruction error of other samples outside the associated class or classes generally would not reconstruct accurately enough to meet the reconstruction error threshold.

Generally, each layer 162a through 162h of AI model 132 comprises a corresponding array of nodes 164a through 164h, respectively. Each node 164a through 164h generally performs at least one function and/or transformation on the supplied data to produce an output. The operations or transformations used by each node 164a through 164h may have one or more parameters, coefficients, or the like. Optionally, a bias also may be applied at each node 164a through 16h, respectively. The output of each node 164a through 164h is referred to in the field of artificial intelligence as its activation value or its node value.

The pathways 166a through 166i by which information flows to and from the hidden layers 162a through 162h also are known as links. Each pathway 166a through 166i may be characterized by a weight. In many modes of practice, each node 164a through 164h and 153 receives a weighted combination of input signals from a plurality of weighted pathways 166a through 166i, as the case may be. The weighting of each pathway means that the resulting composite input can have a different influence on any subsequent calculations, and ultimately on the final output dataset 152 depending on how the various weights are set. The combination of weighted input signals and the functions, bias, and/or transformations applied throughout AI model 132 may be linear and/or nonlinear.

The flow of information through the hidden layers 162a through 162h may occur via forward pass propagation and/or a backward pass/backward propagation. For purposes of illustration, the architecture of AI model 132 is shown with forward pass characteristics where data flows in a downstream direction shown by arrow 165.

Desirably, a degree of data compression occurs progressively at each layer 162a through 162d. This is shown schematically by the decreasing number of nodes 164a through 164d in each of layers 162a through 162d, respectively. In some modes of practice, the data compression may occur steadily through each successive layer 162a through d. Alternatively, the progress of the compression may be nonlinear.

Also desirably, a degree of data decompression occurs progressively at each layer 162e through 162h. This is shown by the increasing number of nodes 164e through 164h in each of the layers 162e through 162h, respectively. In some modes of practice, the data decompression may occur steadily through each successive layer 162e through 162h. Alternatively, the progress of the decompression may be nonlinear.

The number of hidden layers through which data compression occurs in AI model 132 may be selected from a wide range. In many embodiments, compression occurs through one or more hidden layers, preferably two or more hidden layers. In many embodiments, compression may occur in as many as 5 or more layers, even 10 or more layers, or even 20 or more layers. In preferred modes of practice, compression occurs in 1 to 20 hidden layers, preferably 2 to 10 hidden layers, more preferably 2 to 5 hidden layers. As illustrated in FIG. 8a, AI model 132 includes four layers 162a to 162d that progressively compress data.

The number of hidden layers through which data decompression or expansion occurs in AI model 132 may be selected from a wide range. In many embodiments, decompression/expansion occurs through one or more hidden layers, preferably two or more hidden layers. In many embodiments, decompression/expansion may occur in as many as 5 or more layers, even 10 or more layers, or even 20 or more layers. In preferred modes of practice, decompression/expansion occurs in 1 to 20 hidden layers, preferably 2 to 10 hidden layers, more preferably 2 to 5 hidden layers. As illustrated in FIG. 8a, AI model 132 includes four layers 162e to 162h that progressively decompress/expand data.

The number of hidden layers in AI model 132 that compress data may be the same or different from the number of hidden layers that decompress/expand data. For purposes of illustration, AI model 132 includes an equal number of hidden layers that compress and decompress/expand data. That is, the four layers 162a through 162d compress data, and an equal number of layers 162e to 162h decompress/expand data.

AI model 132 desirably compresses and decompresses/expands the dataset 150 so that the reconstructed dataset 152 matches the input dataset 150 in size. For example, the number of values 151in input dataset 150 is the same as the number of values 153 in reconstructed dataset 152. This allows corresponding data point pairs in the input and reconstructed datasets 150 and 152 to be directly compared to determine reconstruction error characteristics in a more straightforward manner than if the two data sets were sized differently.

FIG. 8b schematically illustrates an alternative embodiment of an AI model 132′ that can be used in the practice of the present invention instead of AI model 132 of FIGS. 7 and 8a. AI model 132′ transforms the data values 151 of input dataset 150 into the data values 153′ of reconstructed dataset 152′. AI model 132′ includes an architecture that includes a data expansion region 133 and a data compression region 135 downstream from the data expansion region 133. As a flow of data is transformed by AI model 132′, the data is first expanded in the data expansion region 133, and then the data is compressed to produce the reconstructed dataset 152′ in the data compression region 135. As illustrated, the data expansion region 133 has a shorter length L1 than the length L2 of the data compression region 135. This schematically illustrates that the data expansion region 133 has a lesser number of hidden layers than the data compression region 135. In other embodiments, the length L1 (and hence the number of hidden layers) can be greater than L2 or even equal to L2 (in which case both regions 133 and 135 would have the same number of hidden layers).

Training of AI model 132 of FIGS. 7 and 8a or AI model 132′ of FIG. 8b may occur by adjusting weights, parameters, bias, thresholds, or other value in accordance with one or more training methodologies practiced in the field of artificial intelligence. In some training strategies, the adjustment occurs as a function of the deviation of the reconstruction error characteristics from the desired error specification. Training can occur using inductive and/or deductive learning. Knowledge based inductive learning (KBIL) is an example of inductive learning. KBIL focuses on finding inductive hypotheses on a dataset with the help of background information. Explanation based learning (EBL) and relevance-based learning (RBL) are examples of deductive learning. EBL extracts general rules from examples by generalizing explanations. RBL identifies attributes and deductive generalization from examples. AI training can use one or more feedback strategies. Examples include unsupervised learning, supervised learning, semi-supervised learning, and/or reinforcement learning.

A variety of functions and transformations can be independently used singly or in combination among the different nodes in the AI models 132 or 132′, as the case may be, including but not limited to linear regression, nonlinear regression, Laplace transformation, integration, derivatization, sigmoid, hyperbolic tangent, inverse hyperbolic tangent, sine, cosine, Gaussian error linear units, exponential linear unit, scaled exponential linear unit, Softplus function, Swish function, Gudermannian function, rectified linear unit, leaky rectified linear unit, clipped rectified linear unit, activation function, complex nonlinear function, learning vector quantization, smash functions or other normalization, and the like. Desirably, one or more activation functions are used to incorporate non-linear properties to the neural network transformation to avoid using only linear mappings from the input values to the output values.

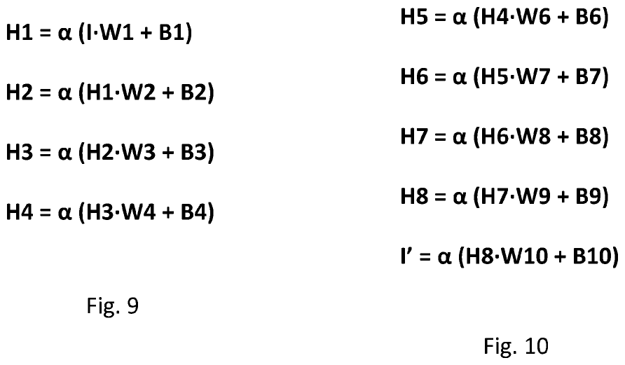

FIG. 9 schematically illustrates an exemplary set of operations performed on the input dataset 150 of FIG. 8 in order to obtain a compressed dataset as a result of processing data through the hidden layers 162a to 162d. The input dataset 150 is represented by matrix I; the compressed dataset 156 is represented by the matrix H4; the node activation values produced by the nodes 164a to d in each of layers 162a to d, respectively, are represented by the matrices H1, H2, H3, and H4, respectively; each of B1, B2, B3, and B4, respectively, is a bias matrix added to the dot products in each layer; the weight matrix applied to each of the pathways 166a to d are given by W1, W2, W3, and W4, respectively; and a represents an arbitrary activation function. Given the input matrix I, a dot-product with respect to the first weight matrix W1 is computed, a bias matrix B1 is added, and the activation function a is applied to the result. The result is the new matrix H1. The matrix H1 is then used as the new input matrix for the next layer, where the same operations are applied to provide H2. This is repeated until the compressed dataset H4 is obtained. The function H4=F(I) represents the overall transformation function that processes the input matrix I through the layers of neurons to provide the compressed data matrix.

FIG. 10 schematically illustrates an exemplary set of operations performed on the compressed dataset H4 of FIG. 9 in order to obtain the decompressed, reconstructed, output dataset I′ as a result of processing data through hidden layers 162e to 162h. The compressed dataset is represented by matrix H4; the decompressed, reconstructed, output dataset is represented by the matrix I′; the node activation values produced by the nodes 164e to h in each of layers 162e to h, respectively, are represented by the matrices H5, H6, H7, and H8, respectively; the weight matrix applied to each of the pathways 166e to i are given by W6, W7, W8, W9, and W10, respectively; each of B6, B7, B8, B9, and B10 respectively, is a bias matrix added to the dot products in each layer; and a represents an arbitrary activation function. Given the input matrix H4, a dot-product with respect to the first weight matrix W6 is computed, a bias matrix B6 is added, and the activation function a is applied to the result of this. The result is the new matrix H5. The matrix H5 is then used as the new input matrix for the next layer, where the same operations are applied to provide H6. This is repeated until the output dataset I′ is obtained. The function I′=F(H4C) represents the overall transformation function that processes the matrix H4 through the layers of neurons to provide the output matrix I′.

FIG. 11a schematically illustrates how trained AI models 200, 202, and 204 of the present invention may be used to determine if samples 210, 212, 214, and 216 are in any of the classes for which the AI models 200, 202, and 204 were trained. Each model 200, 202, and 204 was trained to compress input data from training samples of one type and then to decompress them back with the goal to minimize the reconstruction error. Thus, each AI model 200, 202, and 204, respectively is trained with respect to only one associated class T1, T2, and T3, respectively. The result of training is that AI model 200 is specialized to minimize the reconstruction error when a sample is in class T1. AI model 202 is specialized to minimize the reconstruction error when a sample is in class T2. AI model 204 is specialized to minimize the reconstruction error when a sample is in the class T3. For purposes of illustration, each of AI models 200, 202, and 204 independently was trained to achieve a reconstruction error within corresponding, desired error specifications for the training samples in the associated class. The error specifications may be the same or different among the different models 200, 202, and 204.

Each of models 200, 202, and 204 independently includes a compressing portion 206 and a decompressing portion 208. The compressing and decompressing portions 206 and 208 are unique as to each model 200, 202, and 204 given the specialized training of each model 200, 202, and 204. The compressing portion 206 of each model 200, 202, and 204 compresses the input data to provide compressed data. The decompressing portion 208 of each model 200, 202, and 204 decompresses the compressed data to provide the reconstructed data 211, 213, 215, and 217 outputs from each model 200, 202, and 204 for the four samples 210, 212, 214, and 216, respectively. The compressing portion 206 takes data 221, 223, 225, and 227 from the samples 210, 212, 214, and 216, respectively, as its inputs, while the decompressing portion 208 takes the compressed output of the associated compressing portion 206 as its input.

Training is simplified with this approach. Since each model is only responsible to minimize the reconstruction error of samples from one class type, only samples of the associated class type or types need to be used as training samples of each model. Counterfeit or other samples outside the associated class type or types need not be used for training. This reduces computation time and cost. Multiple models are easily trained, wherein each model specializes in reconstructing samples of one or more associated class types. Since this reconstruction strategy does not rely on probabilities relative to two or more classes being processed through the same model, the samples of other types have no influence on the training process of a particular type. As compared to probabilistic models, the resultant library of specialized models better handles situations in which an unknown sample is a counterfeit that is relatively close in characteristics to one class type but is significantly different from the other class types associated with the library. As noted in the background section, such a situation can confuse probabilistic models due to the skewed normalization problem, which could have a tendency to cause greater instances of false classifications of such counterfeit materials.

With models 200, 202, and 204 being trained, the models 200, 202, and 204 can be used to evaluate and classify samples 210, 212, 214, and 216. Low reconstruction error within the error specification should result if a sample 210, 212, 214, or 216 is within a class associated with a particular model 200, 202, and 204. A relatively high reconstruction error outside the error specification should result if a sample 210, 212, 214, or 216 is not within a class for which a model 200, 202, or 204 is specialized. It follows that reconstruction error for a sample that is outside all of classes T1, T2, and T3 should be outside the corresponding error specification with respect to all the models 200, 202 and 204.

FIG. 11b schematically shows exemplary results 230 that might result when applying models 200, 202, and 204 to each of samples 210, 212, 214, and 216, respectively. Results 230 as shown in FIG. 11b are in the form of a table in which the reconstruction errors are expressed as RMSE values. Assuming for purposes of illustration that each of the models 200, 202, and 204 is trained to recognize a sample within the associated class according to a reconstruction error of less than 3, the results show that sample 210 is in class T1, sample 212 is in class T2, and sample 214 is in class T3. This is shown by the fact that the reconstruction error is only within the error specification for these matches, respectively. In the meantime, the reconstruction error for sample 216 is outside the error specification when any of models 200, 202, or 204 is applied. This shows that sample 216 is not in any of the T1, T2, or T3 classes. In some contexts, this would indicate that sample 216 is counterfeit. The close proximity of the reconstruction error (7.5 of sample 216 with respect to model 204 could indicate that sample 216 is a counterfeit that attempts to mimic class T3.

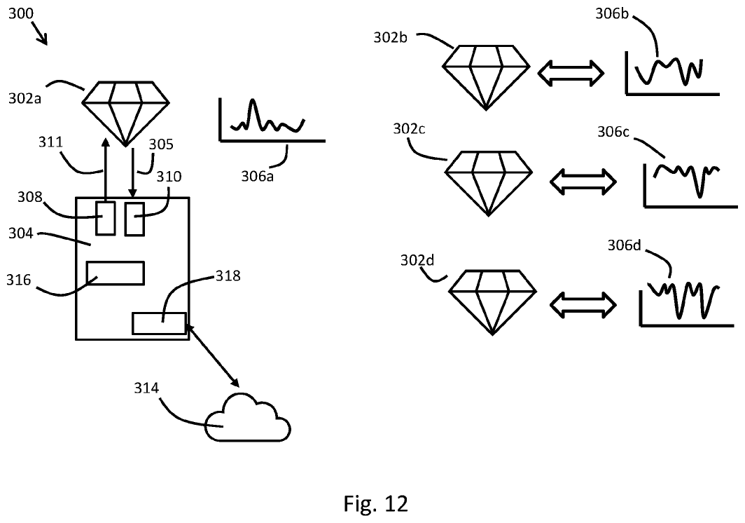

FIG. 12 shows a system 300 useful for practicing principles of the present invention by which AI strategies use characteristics a diamonds 302a, 302b, 302c, and 302d to assess provenance. “Provenance” is a term in the gemstone industry used to describe the geographic origin from which a gemstone originates. Gemstones from a particular region tend to have a unique set of characteristics, much like a fingerprint. Gemstones from other regions would not have matching characteristics. Therefore, a gemstone having the unique set of characteristics can be identified as coming from the particular region. A gemstone without the unique set of characteristics can be ruled out as coming from the particular region and instead must come from a different region. In embodiments of the present invention discussed above, a taggant associated with an item provides a spectral signature that is used for classification. Gemstone provenance needs no taggant, as the spectral characteristics of the gemstone itself incorporate the information needed to assess provenance.

Reader device 304 is used to read the spectral characteristics 306a, 306b, 306c, and 306d of the diamonds 302a, 302b, 302c, and 302d, respectively. Reader includes laser diode 308, and sensor array 310. Laser diode 308 illuminates a gemstone. For illustration, diamond 302a is illuminated. The illumination 311 from diode 308 triggers diamond 302a to emit a spectral response 305 that is read by sensor array 310. The spectral response 305 incorporates spectral characteristics 306a. Similarly, the spectral responses of the other diamonds 302b, 302c, and 302d incorporate respective spectral characteristics 306b, 306c, and 306d. The sensed data is stored in the cloud 314. Note how each set of spectral characteristics 306a, 306b, 306c, and 306d is different from the others. This indicates each of the diamonds 302a, 302b, 302c, and 302d comes from a different geographic location. A library 316 stores a plurality of AI models of the present invention that respectively correspond to various regions around the world. The AI models can be used to reconstruct the spectral characteristics 306a, 306b, 306c, and 306d to determine which AI model properly reconstructs the data for each diamond 302a, 302b, 302c, and 302d, respectively. In accordance with the principles of the present invention, the geographic region whose AI model properly reconstructs the data for a particular diamond can be identified as the origin for that gemstone. Hardware processor 318 provides the computing resources to help handle the illumination, sensing, storing, comparing, etc.

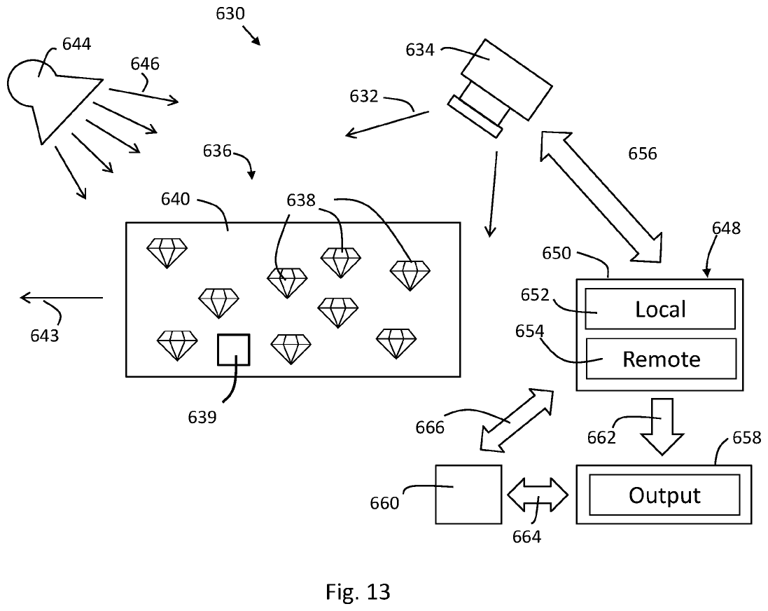

FIG. 13 schematically shows an illustrative system 630 of the present invention that uses a combination of visual imaging (e.g., image capture that encodes the visual characteristics of a field of view) and multispectral/hyperspectral imaging techniques to capture spectral information from gemstones 638 so that principles of the present invention may be used to classify the gemstones 638. For purposes of illustration, gemstones 638 are diamonds. Each gemstone 638 respectively is marked with a taggant system (not shown). Each different taggant system if present corresponds to an associated geographic location, respectively. Hence, identifying or classifying the taggant system on each gemstone 638 allows the provenance of each gemstone 638 to be determined. Depending on circumstances, gemstones 638 may originate from one or more geographic locations and, therefore, may incorporate one or more different taggants systems as the case may be.

System 630 can be used remotely detect if taggant systems are present on one or more of the gemstones 638 in the field of view 632 of a multispectral/hyperspectral image capturing device 634. The system 630 then produces an output 658 that may indicate if a taggant signature is detected and may produce an output image (not shown) of the scene that highlights gemstones 638 in the scene whose pixel(s) produced spectral signature(s) of interest. A variety of different imaging devices with multispectral/hyperspectral imaging capabilities are commercially available. Examples of commercially available imaging devices with these capabilities are the hyperspectral cameras commercially available under the SPECIM FX SERIES trade designation from Specim Spectral Imaging Oy Lt., Finland.

For purposes of illustration, system 630 is being used to analyze a scene 636. The scene 636 includes a plurality of gemstones 638 in the form of rough, mined diamond stones being transported on conveyor 640 in the direction of arrow 643 for further handling. Gemstones 638 have been marked with taggant systems according to the geographic location or even more specifically the mine (not shown) from which the gemstones 638 were mined. Each geographic location or mine in this illustration is associated with its own, unique spectral signature(s), and gemstones 638 from that mine have been marked with corresponding taggant particles that encode the proper, unique spectral signature(s). An exemplary objective of system 630 in this illustration is to remotely scan the gemstones 638 in order to confirm that the gemstones 638 are sourced from authorized mines rather than being injected into the process from an unauthorized mine. One reason to track gemstones 638 in this manner is to be able confirm to a downstream buyer or other entity that a particular stone is sourced from a particular authorized mine. This may be commercially important, because the mine source from which a diamond stone is mined can impact the value or other favor accorded to a stone.

Imaging device 634 is used to capture both visual and multispectral image information of scene 636 remotely from a distance. Images may be captured in a variety of forms including in the form of still images, push-broom images, and/or video images either continuously or at desired intervals. This can occur manually, or the image capture can be automated. An optional illumination source 644 illuminates the scene 636 with illumination 646. Generally, optional illumination source 644 is used to help maintain similar illumination in a variety of reading conditions, as this helps to allow signatures to be defined with tighter tolerances for higher security. In some instances, illumination source 644 may not be needed such as when image capturing device 634 captures image information outdoors in the daytime when there is adequate sunlight. At night time, if it is too cloudy, indoors, or in other low light conditions, or in applications in which ambient illumination could vary unduly, using a broadband white light illumination can be useful to help allow detection of a consistent stronger spectral signature from taggant particles, if present. Further, if any the taggant materials luminesce or otherwise need a particular type of illumination in order to generate a desired spectral output, illumination source 644 may be selected to provide the appropriate illumination. The scene 636 optionally may include a reference plaque 639, such as a white, black, or grey reference surface that serves as an in-frame reference to help calibrate the visual and/or multispectral image information.

Illumination source 644 can illuminate scene 636 with more than one type of illumination 646, often occurring in sequence. Image capturing device 634 may then read the spectral output of scene 634 associated with each type of illumination. In some embodiments, illumination system 644 may provide illumination 646 that includes two or more, preferably 2 to 10 wavelength bands of illumination in sequence. These wavelength bands may be discrete so that the illuminations do not have overlapping wavelengths. In other instances, the wavelength bands may partially overlap. For example, an illumination providing predominantly illumination in the range from 370 nm to 405 nm would be distinct from an illumination providing predominantly illumination in a range from 550 nm to 590 nm. As another example, three illuminations in the wavelength ranges 380 nm to 430 nm, 410 nm to 460 nm, and 440 nm to 480 nm, respectively are different types of illumination even though each partially overlaps with at least one other wavelength band.

Generally, illumination source 644 uses one or more types of illumination 646 that are used that are able to help produce appropriate spectral output from the taggant particles that provide the proper spectral signature(s). For example, illumination 646 can be in the form of bright, broad band light such as is emitted by a halogen bulb. In some modes of practice, the halogen bulb may stay on continuously or can be modulated.

Many other kinds of different illumination sources 644 can be used. Light emitting diodes (LED's) are convenient illumination sources. LED's are reliable, inexpensive, uniform and consistent with respect to illumination wavelengths and intensity, energy efficient without undue heating, compact, durable, and reliable. Lasers, such as laser diodes, can be used for illumination as well. As one advantage, laser illumination has a tight spectral output with high intensity. Broadband white light is suitable in some embodiments.

Image capture device 634 provides captured image information to control system 648. Control system 648 generally includes controller 650, output 658, interface 660, and communication pathways 656, 662, 664, and 666. Communication pathway 656 allows communication between image capture device 634 and controller 650. Some or even all aspects of controller 650 may be in local components 652 that are incorporated into image capture device 634 itself. Other aspects of controller 650 optionally may be incorporated into one or more remote server or other remote-control components 654. Communication pathway 662 allows controller 650 to communicate with output 658. Communication pathway 664 allows the output 658 and interface 660 to communicate. Communication pathway 666 allows the interface 660 and the controller 650 to communicate.

Control system 648 desirably includes a hardware processor that causes execution of suitable program instructions that evaluate the captured information in order to classify the detected spectral signatures. In accordance with principles of the present invention, A library 316 stores a plurality of AI models of the present invention that respectively correspond to various regions around the world. The AI models can be used to reconstruct the multispectral characteristics of the gemstones 638 to determine which AI model, if any, properly reconstructs the data for each gemstone 638, respectively. In accordance with the principles of the present invention, the geographic region whose AI model properly reconstructs the data for a particular gemstone 638 can be identified as the origin for that gemstone. Control system 648 provides the computing resources to help handle the illumination, sensing, storing, comparing, etc.

Control system 648 provides an output 658 in order to communicate the results of the evaluation. The output 658 can indicate whether an authentic taggant signature is detected for each gemstone 638 and can identify which geographic region or mine is associated with each gemstone 638 having an authentic taggant signature. If it is detected, the output 158 can show the labeled provenance of each gemstone 638 in the captured image of the field of view 632.

The output 658 may be provided to other control system components or to a different system in order to take automated follow up action based on the results of the evaluation. The output 658 also may be provided to a user (not shown) through interface 660. Interface 660 may incorporate a touch pad interface and/or lights whose color or pattern indicates settings, inputs, results, or the like. Interface 660 may as an option may include a voice chip or audio output to give audible feedback of pass/fail or the like. Additionally, controls (not shown) may be included to allow the user to interact with the control system 648.

The present invention will now be described with reference to the following illustrative examples.

### Example 1

### Preparation of Tagged and Untagged Samples

Eight different sample types were prepared to represent seven different classes. These were the T1 to T7 classes, respectively. Two types of samples were prepared for the T3 class in order to test the ability of the AI models to accurately classify samples from the same class that are deployed in a different manner. Samples T1 to T7 correspond to Classes T1 to T7, respectively.

Sample T1 was prepared as follows. IR (infra-red) absorbing dye, IR-T1 as a taggant system associated with Class T1, was placed into an optically transparent, water-based base ink at a loading of 3 parts by weight of the IR-T1 dye per 100 parts by weight of the water-based ink. The mixture of the ink and the IR dye, IR-T1, was then bead milled for 5 minutes at 4k speed in a StateMix Vortex lab mixer. The resultant, milled taggant ink containing the IR-T1 dye was then printed onto a metallic substrate via a drawdown process using a Harper QD proofer at speed setting of 10, anilox roller of 8.5 bcm, and transfer roller of 65 durometer.

Sample T2 was prepared as follows. IR (infra-red) absorbing dye, IR-T2 as a taggant system associated with Class T2, was placed into an optically transparent, water-based ink at a loading of 3 parts by weight of dye per 100 parts by weight of the water-based ink. The mixture of the ink and the IR dye, IR-T2, was then bead milled for 5 minutes at 4k speed in a StateMix Vortex lab mixer. The resultant, milled taggant ink containing the IR-T2 dye was then printed onto a metallic substrate via drawdown process using a Harper QD proofer at speed setting of 10, anilox roller of 8.5 bcm, and transfer roller of 65 durometer.

Sample T3a was prepared as follows. IR (infra-red) absorbing dye, IR-T3 as a taggant system associated with Class T3, was placed into an optically transparent water-based ink at a loading of 3 parts by weight of dye per 100 parts by weight of the water-based ink. The mixture of the ink and the IR dye, IR-T3, was then bead milled for 5 minutes at 4k speed in a StateMix Vortex lab mixer. The resultant, milled taggant ink containing the IR-T3 dye was then printed onto a metallic substrate via drawdown process in the lab using a Harper QD proofer at speed setting of 10, anilox roller of 8.5 bcm, and transfer roller of 65 durometer.

Sample T3b was prepared as follows. IR (infra-red) absorbing dye, IR-T3 as the taggant system also associated with Class T3, was placed into a grey pigmented, water-based ink at a loading of 3 parts by weight of dye based on 100 parts by weight of the water-based ink. The mixture of the ink and the IR dye, IR-T3, was then bead milled for 5 minutes at 4k speed in a StateMix Vortex lab mixer. The resultant, milled taggant ink containing the IR-T3 dye was then printed onto a non-metallic opaque white substrate via drawdown process in the lab using a Harper QD proofer at speed setting of 10, anilox roller of 8.5 bcm, and transfer roller of 65 durometer.

Sample T4 was prepared as follows. IR (infra-red) absorbing dye, IR-T4 as a taggant system associated with Class T4, was placed into an optically transparent, water-based ink at a loading of 3 parts by weight of dye per 100 parts by weight of the water-based ink. The mixture of the ink and the IR dye, IR-T4, was then bead milled for 5 minutes at 4k speed in a StateMix Vortex lab mixer. The resultant, milled taggant ink containing the IR-T4 dye was then printed onto a metallic substrate via drawdown process in the lab using a Harper QD proofer at speed setting of 10, anilox roller of 8.5 bcm, and transfer roller of 65 durometer.

Sample T5 was prepared as follows. IR (infra-red) absorbing dye, IR-T5 as a taggant system associated with Class T5, was placed into a blue pigmented, water-based ink at a loading of 3 parts by weight of dye per 100 parts by weight of the water-based ink. The mixture of the ink and the IR dye, IR-T5, was then bead milled for 5 minutes at 4k speed in a StateMix Vortex lab mixer. The resultant, milled taggant ink containing the IR-T5 dye was then printed onto a non-metallic, opaque white substrate via drawdown process in the lab using a Harper QD proofer at speed setting of 10, anilox roller of 8.5 bcm, and transfer roller of 65 durometer.

Sample T6 was prepared as follows. IR (infra-red) absorbing dye, IR-T6 as a taggant system, was placed into a blue pigmented, water-based ink at a loading of 3 parts by weight of taggant system associated with Class T6, was placed into a blue pigmented, water-based ink at a loading of 3 parts by weight of dye per 100 parts by weight of the water-based ink. The mixture of the ink and the IR dye, IR-T6, was then bead milled for 5 minutes at 4k speed in a StateMix Vortex lab mixer. The resultant, milled taggant ink containing the IR-T6 dye was then printed onto a non-metallic, opaque white substrate via drawdown process in the lab using a Harper QD proofer at speed setting of 10, anilox roller of 8.5 bcm, and transfer roller of 65 durometer.

Sample T7 was prepared as follows. IR (infrared) absorbing dye, IR-T7 as a taggant system associated with Class T7, was placed into a blue pigmented, water-based ink at a loading of 3 parts by weight of dye per 100 parts by weight of the water-based ink. The mixture of the ink and the IR dye, IR-T7, was then bead milled for 5 minutes at 4k speed in a StateMix Vortex lab mixer. The resultant, milled taggant ink containing the IR-T7 dye was then printed on a non-metallic, opaque white substrate via drawdown process in the lab using a Harper QD proofer at speed setting of 10, anilox roller of 8.5 bcm, and transfer roller of 65 durometer.

As described above, Samples T1, T2, T3a, and T4 were prepared by printing the taggant ink onto a metallic substrate, and samples T3b, T5, T6, and T7 were prepared by printing the taggant ink onto a non-metallic substrate. A metallic substrate was chosen for samples T1, T2, T3a, and T4 because taggant systems on a metallic substrate tend to be more difficult to evaluate than those on non-metallic substrates. The reflectivity of the metallic substrate interferes with the spectral emission of the taggant system, which creates a technical challenge in accurately reading spectral signatures. Consequently, it was expected that it would be easier to read spectra from the samples on non-metallic substrates inasmuch as there is much less reflectivity associated with non-metallic substrates as compared to metallic substrates. In fact, it turned out to be the case that spectra were easier to read from the samples with taggant inks printed on the non-metallic substrates. In short, using a metallic substrate created a more challenging situation for reading, evaluating, and classifying the different samples. The ability of the present invention to achieve accurate classification even with metallic samples highlights the ability of the present invention to provide accurate classification in the face of such challenges.

Each of the seven T1 to T7 taggant systems was unique. Each included a unique IR dye having spectral characteristics that provide a unique spectral signature that is different from the spectral signatures of the other six taggant systems. However, the IR dyes chosen were spectrally close to one another in their respective signature characteristics. The dyes were also formulated into the taggant inks at a low loading. Just like using a metallic substrate provided a tougher proving ground for evaluating the performance of the present invention, these factors also created a more challenging situation for reading, evaluating, and classifying the different samples.

### Example 2

### Obtaining Training Scans of the Tagged Samples

Fifteen different, handheld reflectance spectrometers were used to collect 50-250 scans of each tagged sample of Example 1, per detector. Using multiple detectors to collect scans allowed the evaluation of Example 5 below to show that variance among detectors is accommodated sufficiently by the approach of the present invention so that models can be trained to accommodate variance among detectors while still maintaining accurate classification rates. A total of 4203 scans were obtained. These were divided into a training group and a reserved group to be used to later test the classification abilities of the trained AI models. The training group included 3783 (90%) of the scans, and these training scans were used to train a specialized AI model for each of classes T1 to T7, respectively. The reserved group included 420 (10%) used to test the classification abilities of the trained AI models. In this way, the scans used to test classification abilities of the trained models were not used to train the models in the first instance.

An additional fifty scans were added to the reserved group as described below in Example 4 to provide a total of 470 scans that were used to test the classification abilities of the trained AI models. These additional 50 scans included scans of the tagged samples of Example 1 as well as scans of samples without any taggant system (untagged samples). The use of the untagged samples allowed testing to evaluate if the trained AI models could successfully determine that the untagged samples did not belong to any of the seven T1 to T7 classes.

To trigger emission of each spectrum, the training samples were illuminated using two light sources in sequence: first a broad-band white light (400-1000 nm) and then a 910 nm IR light. The spectrum from 400 nm to 1000 nm was collected under each illumination type. This resulted in the collection of two kinds of spectra for each scan sample. Each type of spectrum included 600 data points over the wavelength range of 400 nm to 1000 nm. The 600 data values of the TR reflectance spectrum were added to the end of the 600 data values from the visible reflectance spectrum for a resulting data string containing a total of 1200 individual data values.

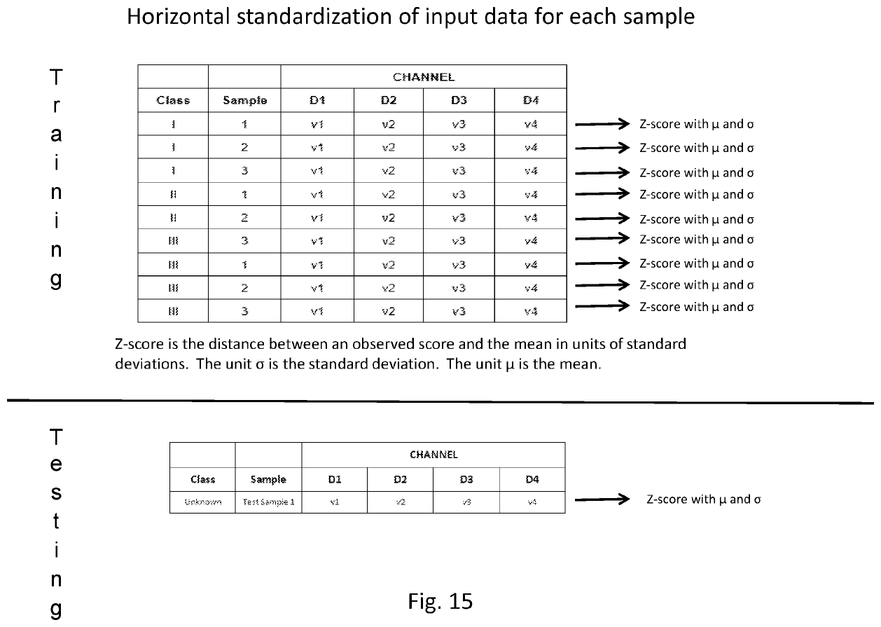

For each data string of 1200 values, a smoothing transformation was performed. The smoothing average was computed for a window size of 15 (i.e., every 15 values). The window was centered at each value, thus including seven neighboring values before the current value, the current value, and the seven neighboring values after the current value. If less than seven neighboring values were available such as at the beginning and end of the data string, only the available values were used for smoothing. For example, for the first value in the string, there would be no neighboring values before the first value. Consequently, on the first value and the seven neighboring values after the current value were used to compute the smoothed value for the first value. A horizontal (see FIG. 15 and corresponding discussion below for an explanation of horizontal standardization) standard normal variate (SNV) transformation was then applied to each scan in order to normalize the data at each smoothed value as follows:

$$New value = ( Old value - mean of all old values ) / Stdev of all old values$$

In this expression, the term “Stdev” refers to the standard deviation. The resultant normalized and smoothed data string served as the input data set for that scan sample. In this example, all 1200 data values were normalized as a single set. As an alternative, each data set of 600 values can be normalized, and then the two normalized data strings can be concatenated to provide an input dataset with 1200 values.

### Example 3

### Using the Scans to Train the AI Models

Seven AI models having the AI architecture similar to that of FIG. 8a were trained using the scans of Example 2. As shown in FIG. 8a, each model had a first compressing portion that progressively compressed the input dataset and a second, decompressing portion that progressively decompressed the compressed data to provide a reconstructed dataset. The compressing portion of each AI model included 6 hidden layers. The decompressing portion of each AI model also included 6 hidden layers that progressively decompressed the data to a provide a reconstructed dataset including the same number of data values to match the size of the input dataset.

Each model was trained to be specialized to properly reconstruct the spectrum, and hence spectral signature, for only one associated taggant class from among the T1 to T7 classes, respectively. Also, each model was trained using only training samples for the associated class. Hence, a T1 AI model was trained using only scans as training samples obtained from Sample T1. Similarly, a T2 AI model was trained using only scans as training samples obtained from Sample T2. Similarly, each of the T3 to T7 models was trained using only scans as training samples obtained from Samples T3 to T7, respectively.

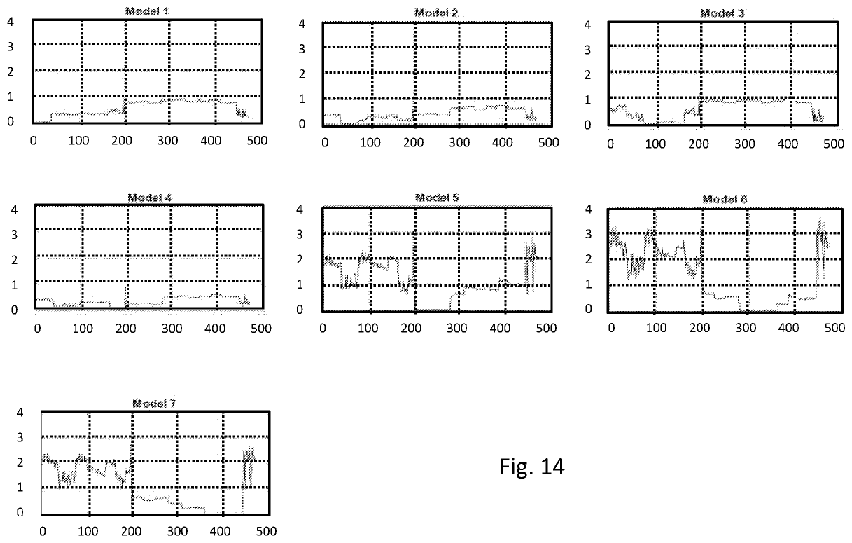

The T3 model was trained using scans from both the T3a and T3b samples. These two samples included the same taggant system, but these were used on two different substrates with two different ink carriers, respectively. The data in FIG. 14 show that the trained T3 AI model can still accurately recognize the T3 taggant system and differentiate it from other taggant systems and untagged samples even when differences in the ink system and substrate are present.

Example 4 below describes obtaining spectral scans from a variety of different untagged samples. No model was trained for the untagged samples. The untagged samples were used in Example 5 to evaluate the trained models to see if any of the seven trained models would confuse the untagged samples as being in any of the T1 to T7 classes associated with the trained AI models, respectively.

### Example 4

### Obtaining Fresh Sample Scans

In this example, 50 additional scan samples from both the tagged samples of Example 1, as well as from additional untagged samples, were obtained. Of these, 24 scans were obtained from the tagged samples, and 26 scans were obtained from the untagged samples.

Scans of the 50 additional samples were obtained from the tagged and untagged samples using the procedures as described above with respect to Example 2, except that the same detector was used to obtain all 50 scans. Further, three scans were taken from the samples prepared on metallic substrates, and the data values used for smoothing and normalization were the averages of the three readings. Further, only a single scan was taken from the samples on non-metallic substrates.

As a result of combining the 420 scans from the reserved group with the 50 additional scans, a full, reserved group of 470 scans was formed in order to test the classification abilities of the seven, trained AI models resulting from Example 3, and their associated taggant systems (also referred to as the associated taggant class), or lack thereof in the case of untagged samples, are shown in the following table:

| Scan Sample | Associated Taggant |
|---|---|
| Number | System |
| 1-38 (metallic) | T1 |
| 39-76 (metallic) | T2 |
| 77-106 (Sample 3a, | T3 |
| metallic substrate) | |
| 107-163 (Sample 3b, non- | T3 |
| metallic substrate) | |
| 164-199 (metallic) | T4 |
| 200-278 (non-metallic) | T5 |
| 279-358 (non-metallic) | T6 |
| 359-444 (non-metallic) | T7 |
| 445-470 (mixed metallic | Untagged |
| and non-metallic) | |

Scans from a variety of different untagged items were obtained. Samples 445 and 458 were scans of an orange, 3M post-it note. Scans 446 and 459 were scans of the metallic gold foil label of “At the Beach” body lotion from Bath and Body Works. Samples 447 and 460 were scans of a matte black countertop. Samples 448 and 461 were scans of a blue 3M post-it note. Samples 449 and 462 were scans of a non-metallic, grey, University of St. Thomas folder. Samples 450, 451, 463, and 464 were scans of the metallic gold foil label of “In the Stars” body lotion from Bath and Body Works. Samples 452 and 465 were scans of the metallic surface of a Dell laptop computer. Samples 453 and 466 were scans of the metallic substrate used to make the metallic samples of Example 1 but with no ink. Samples 454 and 467 were scans of the metallic substrate used to make the metallic samples of Example 1 coated with a UV curable clear varnish applied via drawdown process in the lab using a Harper QD proofer at a speed setting of 10 with and anilox roller of 8.5 bcm and a transfer roller of 65 durometer. Samples 455 and 468 were scans of the metallic pink label of “Pink Coconut Calypso” body lotion from bath and body works. Samples 456 and 469 were scans of the metallic pink label of “Pink Coconut Calypso” body wash from Bath and Body Works. Samples 457 and 470 were scans of a non-metallic white standard from Leneta Co.

### Example 5

### Using the 470 Scans to Evaluate the Ability of the AI Models to Accurately Classify Samples

In this example, the 470 scans of Example 4 were used to classify the tagged and untagged samples associated with those scans. Each AI model was used to evaluate and obtain reconstructions errors for all the samples. For each model, the reconstruction errors of all 470 samples were plotted as a function of sample. The resultant plotted results for each AI model are shown in FIG. 14. In FIG. 14, the graphs for the T1 to T7 AI models are labeled with the heading Model 1 to Model 7, respectively. Hence, the model 1 graph is for the T1 AI model, the model 2 graph is for the T2 AI model, etc.

As a general, overall result, the graphed data in FIG. 14 show that a sample can be classified into the class whose AI model produced reconstruction errors under the error specification if a specification is set. Alternatively, a sample can be classified into the class whose associated model produced the lowest reconstruction errors. It can also be seen that the reconstruction errors for about 95% of the untagged samples was relatively high for all the models, showing that these samples do not belong to any of the 7 classes.

For example, Samples 1-38 are in the T1 class. Reconstruction errors were the lowest and were below 0.1 only for the T1 model. All the other models providing higher reconstruction errors ranging from around 0.4 for the T2 model to as high as about 3.3 for the T6 model.

Samples 39-76 are in the T2 class. Only use of the T2 model provided the lowest reconstruction errors below about 0.1 for these samples. All the other models provided higher reconstruction errors.

Samples 77-163 are in the T3 class. Only use of the T3 model provided the lowest reconstruction errors below about 0.1 for these samples. All the other models provided higher reconstruction errors. The T3 AI model was also sensitive enough not only to distinguish the T3 samples for other samples but also to distinguish the T3a and T3b samples from each other.

Samples 164-199 are in the T4 class. Only use of the T4 model provided the lowest reconstruction errors below about 0.1 for these samples. All the other models provided higher reconstruction errors.

Samples 200-278 are in the T5 class. Only use of the T5 model provided the lowest reconstruction errors below about 0.1 for these samples. All the other models provided higher reconstruction errors.

Samples 279-358 are in the T6 class. Only use of the T6 model provided the lowest reconstruction errors below about 0.1 for these samples. All the other models provided higher reconstruction errors.

Samples 359-444 are in the T7 class. Only use of the T7 model provided the lowest reconstruction errors below about 0.1 for these samples. All the other models provided higher reconstruction errors.

Samples 445-470 are not in any of the T1-T7 classes, as these samples are untagged. All models provided high reconstruction error outside the error specification for a majority of the untagged samples. If the reconstruction errors of the untagged samples are higher than an appropriately selected threshold, then the untagged samples can be predicted as being untagged. If the reconstruction error of an untagged sample were to be lower than the defined threshold, then the untagged sample could be classed as a type within the model that produced the lowest reconstruction error. If such a situation were to occur, the untagged sample would be misclassified. This situation should be uncommon when the models are well trained. Evaluation of the data obtained in this example indicates that misclassification occurred for less than 5.5% of the samples. This is a dramatic improvement over probabilistic classification, where the misclassification would be expected to be 20% or more.

The results show how each AI model can be trained to specialize in the proper reconstruction of a unique associated class. The results show how the reconstruction errors tend to be only low for samples in the associated class. Although Samples over metallic substrates were more difficult to classify due to increased noise in spectra, nonetheless the method of classification taught by the present invention shows an ability to accurately classify even these more difficult samples.

After training, the classification accuracy of the AI models was evaluated using three different error thresholds of less than 0.1071, less than 0.1183, and less than 0.1280, respectively. These were the 3 minimum reconstruction error values for the untagged samples. The three error thresholds led to 88.9%, 94.5%, and 97.2% of overall classification accuracy, respectively. The results show that overall accuracy can be tuned by adjusting the error threshold to fit the needs of different applications.

### Example 6

### Preparation of Samples

Examples 1 to 5 above describe experiments in which classification strategies of the present invention were applied to spectral scans that provided 1200 data values to use as an input data set to train and then use AI models. The results obtained from the training and use of the models show that input data sets including a large number of values allowed the AI models to be trained and then to provide classification with high accuracy. The preparation and testing of Samples according to this Example 6 and Examples 7 to 12 below were performed to show how the classification strategies of the present invention are highly accurate even in the much simpler scenario in which an input data set includes only five data values. As compared to using an input dataset with 1200 dimensions according to the experiments in Examples 1 to 5, the simplicity of this scenario posed a more challenging context for the advantages of the present invention to be demonstrated over conventional classification strategies. Significantly, however, even when reconstructing an input data set with 5 values, the classification strategies of the present invention (referred to herein as reconstruction or RE* classification, where the asterisk is used to help highlight that this acronym is associated with the principles of the present invention) outperformed two conventional classification strategies in wide use. These two conventional classification strategies included 1) support vector machine with radial basis nonlinear kernel learning (SVM RBF learning) and 2) AI/Neural Network (NN) learning based on probabilistic classification.

The RE* models used in Examples 7 to 12 had an architecture as described above with respect to the AI models of the present invention used in Examples 1 to 5 except that the RE* AI models had shallower layers with smaller neurons at each layer due to the 5-dimensional input data. Consequently, the RE* models were trained to specialize to accurately reconstruct an input data set of five values to a reconstructed data set of five values for one associated class. As a further difference, smoothing was not performed on the input data due to its low 5-dimension input. Z-Score (horizontal standardization) of each sample (horizontal standardization is explained in FIG. 15 and its corresponding discussion below) was still performed.

This evaluation used 13 different classes based on 13 different taggant systems, respectively. Each of classes 1 to 11 was a unique taggant systems used on the packaging of actual products commercialized in the beverage field. End users would use the products with hot water in order to prepare a desired hot beverage. The taggant systems were incorporated into carrier inks to provide corresponding taggant inks that were printed on the corresponding packaging.

Each of Classes 12 and 13 was a variation of Class 1. Class 12 was formulated to use exactly the same taggant system as Class 1 except that the weight loading of one of the components of the taggant system in its ink carrier was higher in Class 12 than that used in Class 1. As compared to Class 1, this caused the intensity peak for the component to be higher relative to the peaks of other taggant material in the taggant system. Class 13 was formulated to use exactly the same taggant system as Class 1 except that the weight loading of one of the components of the taggant system in its ink carrier was lower in Class 12 than that used in Class 1. As compared to Class 1, this caused the intensity peak for the component to be lower relative to the peaks of other taggant material in the taggant system. Thus, Class 12 can also be referred to as Class 12 (High) to indicate its higher taggant loading, while Class 13 can be referred to as Class 13 (Low) to indicate its lower taggant loading.

In addition to the commercially available samples described above, an additional lab-based sample associated with Class 1 was prepared. This sample was formulated to use the same taggant system at the same weight loading in an ink carrier to provide a spectral signature to match the spectral signature of the commercially available Class 1 samples. Accordingly, except for being lab-based, this additional sample is a member of Class 1. For convenience, this additional sample shall be referred to herein as the “Class 1 Target” sample, and its scans are referred to as the “Class 1 Target” scans. The term “Target” is used in these labels to indicate that this sample is intended to be in Class 1 and to distinguish it from the commercially available Class 1 samples.

The overall sample set included 100 Class 1 samples, 10 samples for each of Classes 2 to 11, respectively, 1 Class 12 samples, 1 Class 13 samples, and one Class 1 Target sample.

Scans of the samples were taken. Some of the scans were used for training and the remainder was reserved for testing the performance of the trained models. Specifically, 100 scans were taken of the Class 1 samples, with 80 of these being used for training and 20 being reserved for testing the trained models. 50 scans were taken for the samples in each of Classes 2 to 11, respectively, with 40 of the 50 scans of each class being used for training and 10 being reserved for testing the trained models. 100 scans were taken for the samples in each of Class 12, Class 13, and the Class 1 Target sample, respectively, with 80 of the scans in each class being used for training and 20 being reserved for testing the trained models. 100 scans were taken of the Class 1 Target sample, with all 100 of these being used for testing the trained models and none being used for training. To obtain the scans for the Class 12, Class 13, and Class 1 Target samples, each sample was divided into a grid of 100 squares. A scan was taken from each square of the grid so that the scans were taken from different locations on the sample.

To obtain each scan, a scan of the fluorescent emission of each sample was taken using a detector with a 5-channel color chip. The scan obtained a value for each color channel. To trigger emission of the fluorescent signature of each sample, the sample was illuminated with an LED light source at a wavelength of 385 nm. Scans of the samples used to test the trained models were obtained in the same way. Examples 7 to 12 describe classification experiments undertaken using the scans from the Class 1 to 13 samples.

### Example 7

### Classification Accuracy when Models for all Classes are Trained as a Function of Training Iterations

In this experiment, SVM RBF, NN, and RE* models were trained for Classes 1-13 through 250 training iterations. Training the RE* models involved training one specialized AI model for each class for a total of 13 trained, specialized AI models. Each RE* model was trained using only training samples for the associated class. Hence, the nature of the taggant signatures in the other classes was irrelevant for purposes of training. A significant advantage of the present invention, as shown by the results below, is that the AI models of the present invention provide the best classification performance even when trained in this way. For each of the SVM RBF and NN strategies, one model was trained with respect to all 13 classes.

The same training was repeated using 500 training iterations. The result was a first set of SVM RBF, NN and RE* models trained with 250 iterations and a second set of SVM RBF, NN and RE* models trained with 500 iterations.

After training with respect to 250 iterations or 500 iterations, respectively, the abilities of the corresponding, trained SVM RBF, NN, and RE* models to accurately classify the scans from Classes 1 to 13 as well as from the Class 1 Target class were evaluated. The accuracy results of the two experiments, shown as the percentage of samples that are correctly classed into Classes 1 to 13 (recall that the scans from the Class 1 Target sample are a match for Class 1 and thus should be classed into Class 1), are shown in the following table:

| Training | SVM RBF Model | NN Model | RE* models |
|---|---|---|---|
| 250 iterations | 75.4% | 78.8% | 93.5% |
| 500 iterations | 75.4% | 92.7% | 92.7% |

The results show that the SVM RBF and NN models had low accuracy when trained using 250 iterations, while the RE* models provided 93.5% accuracy overall with respect to all the classes. At 500 training iterations, the SVM RBF model still performed poorly. The NN model at 500 training iterations had comparable accuracy to the RE* models but the following observations can be made: 1) The RE* models were much more accurate than the NN models using only 250 training iterations, showing that the RE* models can be effectively trained using less training iterations, and hence can be trained more quickly and at lower cost; and 2) each RE* model can be trained to achieve the high classification accuracy shown here using only samples of the associated class, so that knowledge of other samples outside the class is not needed.

Note that this experiment presents a context in which all the samples are associated with known classes for which the SVM RBF, NN, and RE* models were trained. This creates a context that is extremely favorable for the SVM RBF and NN models inasmuch as these two conventional models tend to force an unknown sample from an unknown class into one of the known classes. This forcing occurs even if the unknown sample is outside all of the known classes. Although this context favors the SVM RBF and NN models by avoiding new classes not yet encountered, the RE* strategy still outperforms the SVM RBF and NN models at 250 training iterations, and only the NN model matches the RE* model when using 500 training iterations. This shows that the SVM RBF model falls behind in both training scenarios, that the NN model needs extensive training to be highly accurate, and that the RE* models are highly accurate even using lesser training iterations.

Additionally, even though this experiment presents a context in which all samples and classes are known to the models, this is a not real-world scenario. A real scenario would involve newly encountered products from new competitors, new counterfeits, or the like that were previously unknown and not used for training. As will be shown below, the SVM RBF and NN models fail to recognize these new entrants as being outside the known classes, instead forcing them into a known class, making counterfeit detection of newly encountered classes extremely difficult if not impossible. In contrast, and as a significant advantage, the RE* strategy of the present invention can much more accurately recognize that a sample from a newly encountered class is outside of known classes. This advantage results because the RE* does not try to force samples into known classes. Rather, if an unknown produces reconstruction errors that are too high for all AI models, the RE* strategy can accurately determine such a sample does not belong to any of the known classes. This fulfills the strong need to be able to detect newly encountered counterfeits and competitive samples in the market place.

The results also show that the Class 1 Target scans were accurately characterized as being in Class 1 by the RE* models. Also, notwithstanding high similarity to Class 1, the samples from Classes 12 (High) and 13 (Low) were accurately classified by the RE* models as well.

### Example 8

### Classification Accuracy when Simulating a Scenario in which Trained Classification Models First Encounter a Previously Unknown Class

In this experiment, SVM RBF, NN, and RE* models were trained with respect to Classes 1-3, 5-8, and 10-13 using 250 training iterations. This simulates a situation in which the samples associated with Classes 4 and 9 are unknown at the time of training with respect to the RE* models and are counterfeits first encountered by the RE*models later. Training the RE* model involved training one specialized AI model for each of Classes 1-3, 5-8, and 10-13, respectively. Each RE* model was trained using only training samples for the associated class. Hence, the nature of the taggant signatures in the other classes was irrelevant for purposes of training. Additionally, each SVM RBF and NN model in accordance with conventional practice was trained using samples from 1-3, 5-8, and 10-13 collectively while the samples from Classes 4 and 9 were both grouped into an “other” class and used to train the SVM RBF and NN models as the “other” class. This scenario gives a classification advantage to the SVM RBF and NN models as the “other” class was known to these two models at the time of training but were unknown to the RE* strategy at the time of training. Notwithstanding the advantage given to the SVM RBF and NN models, the data below shows that the RE* classification strategy is more accurate.

The same training was repeated using 500 training iterations. The result was a first set of SVM RBF, NN, and RE* models trained with 250 iterations and a second set of SVM RBF, NN, and RE* models trained with 500 iterations.

After training, the ability of the SVM RBF, NN, and RE* strategies to accurately classify the samples as belonging to Classes 1-13. In practical effect, these experiments simulated the ability of the SVM RBF, NN, and RE* models to recognize the samples within the known Classes 1-3, 5-8, and 10-13 while recognizing that the samples from Classes 4 and 9 are outside Classes 1-3, 5-8, and 10-13. The accuracy results of the two experiments, shown as the percentage of samples that are correctly classed, are shown in the following table:

| Training | SVM RBF Model | NN Model | RE* models |
|---|---|---|---|
| 250 iterations | 75.4% | 40% | 86.5% |
| 500 iterations | 75.4% | 65% | 89.6% |

The results show that the SVM RBF and NN models had low accuracy when trained using either 250 or 500 iterations. The low accuracy of these models is due at least in part to the tendency to force the samples from Classes 4 and 9 into one of the other classes and to fail to recognize that the Class 3 and 8 samples do not belong to any of the trained classes. In contrast, the RE* model in the aggregate provided significantly higher accuracy overall with respect to all the samples. The results show that extra training when using 500 iterations did not help the SVM RBF model to improve. The results also show that the extra training when using 500 iterations helped the NN Model, but the accuracy still improved only to 65%, well below the much higher accuracy of 89.6% achieved by the RE* models. In short, the RE* strategy is better able to recognize that newly encountered samples do not belong to a known class.

### Example 9

### Classification Accuracy when Simulating a Scenario in which Trained Classification Models First Encounter a Previously Unknown Class

In this experiment, SVM RBF, NN, and RE* models were trained through 250 iterations with respect to Classes 1, 3-7, and 9-13 using 250 training iterations. This simulates a situation in which the samples associated with Classes 2 and 8 are unknown at the time of training to the RE* models and are counterfeits first encountered by the RE* models later. Training the RE* model involved training one specialized AI model for each of Classes 1, 3-7, and 9-13, respectively. Each RE* model was trained using only training samples for the associated class. Hence, the nature of the taggant signatures in the other classes was irrelevant for purposes of training. Additionally, each of the SVM RBF and NN models in accordance with conventional practice was trained using samples from Classes 1, 3-7, and 9-13 collectively while the samples from Classes 2 and 7 were both grouped into an “other” class and used to train the SVM RBF and NN models as the “other” class. This scenario gives a classification advantage to the SVM RBF and NN models as the “other” class was known to these two models at the time of training but were unknown to the RE* strategy at the time of training. Notwithstanding the advantage given to the SVM RBF and NN models, the data below shows that the RE* classification strategy is more accurate.

The same training was repeated using 500 training iterations. The result was a first set of SVM RBF, NN, and RE* models trained with 250 iterations and a second set of SVM RBF, NN, and RE* models trained with 500 iterations.

After training, the ability of the SVM RBF, NN, and RE* strategies to accurately classify the samples from Classes 1-13 was evaluated. In practical effect, these experiments simulated the ability of the SVM RBF, NN, and RE* models to recognize the samples within the Classes 1, 3-7, and 9-13 while recognizing that the samples from Classes 2 and 8 are outside Classes 1, 3-7, and 9-13. The accuracy results of the two experiments, shown as the percentage of samples that are correctly classed are shown in the following table:

| Training | SVM RBF Model | NN Model | RE* models |
|---|---|---|---|
| 250 iterations | 75.8% | 86.2% | 90.8% |
| 500 iterations | 75.8% | 91.9% | 93.1% |

The results show that the SVM RBF model had low accuracy when trained using either 250 or 500 iterations. In contrast, both the NN and RE* models provided significantly higher accuracy overall with respect to all the samples. Even though the NN model provided relatively high accuracy in this testing scenario, the NN model was much more inaccurate in the scenario of Example 8. In contrast, the RE* models provided relatively high accuracy in both testing scenarios. This shows that the RE* strategy of the present invention provides higher accuracy under a broader range of scenarios than either the SVM RBF or NN models. This also shows that the RE* strategy is better able to recognize that newly encountered samples do not belong to a known class.

### Example 10

### Simulating the Ability of Classification Models to Classify Super Counterfeits

A super counterfeit in general refers to a class that is a fake but has a spectral signature that is extremely close to the spectral signature of the authentic class. Under this definition, each of Class 12 and Class 13 is a super counterfeit with respect to Class 1, if Class 1 is viewed as the authentic class. Classes 12 and 13 have this status because each uses the same taggant system as Class 1 except that the intensity of one component of the taggant system is altered.

In this experiment, SVM RBF, NN, and RE* models were trained with respect to Classes 1-11 using 250 training iterations. This simulates a situation in which the samples associated with Classes 12 and 13 are unknown at the time of training to the RE* models and are counterfeits first encountered by the RE* models later. Training the RE* model involved training one specialized AI model for each of Classes 1-11, respectively. Each RE* model was trained using only training samples for the associated class. Hence, the nature of the taggant signatures in the other classes was irrelevant for purposes of training. Additionally, each SVM RBF and NN model in accordance with conventional practice was trained using samples from Classes 1-11 collectively while the samples from Classes 12 and 13 were both grouped into an“other” class and used to train the SVM RBF and NN models as the “other” class. This scenario gives a classification advantage to the SVM RBF and NN models as the “other” class was known to these two models at the time of training but were unknown to the RE* strategy at the time of training. Notwithstanding the advantage given to the SVM RBF and NN models, the data below shows that the RE* classification strategy is more accurate.

After training, the ability of the SVM RBF, NN, and RE* strategies to accurately classify the samples as belonging to Classes 1-13. In practical effect, these experiments simulated the ability of the SVM RBF, NN, and RE* models to recognize the samples within the known Classes 1-11 while recognizing that the samples from Classes 12 and 13 are outside Classes 1-11. The accuracy results of the experiment, shown as the percentage of samples that are correctly classed, are shown in the following table:

| Training | SVM RBF Model | NN Model | RE* models |
|---|---|---|---|
| 250 iterations | 30.4% | 48.8% | 92.3% |

The results show that the SVM RBF and NN models had much lower accuracy than the RE* models. This shows that the RE* strategy can recognize super counterfeits better than the conventional classification strategies even when the super counterfeit classes are unknown to any of the RE* models during training.

### Example 11

As a drawback of the SVM RBF, NN, and other conventional classification strategies, the corresponding models must be trained with respect to at least two classes. In contrast the strategies of the present invention allow training to occur with respect to only a single class, and the resultant trained model is still able to classify samples as being in the class or outside the class. In practical effect, this means the trained model can actually recognize two classes with excellent accuracy, with the first class being the class associated with the trained model and with the second class being the subject matter outside the associated class. Hence, if “C” represents the number of classes for which a strategy is trained, the traditional methods tend to classify only into C classes with the restriction that C is at least 2. Because of the ability to classify newly encountered classes as being outside known classes, the reconstruction strategies of the present invention can classify in C+1 classes as a practical matter, where C can be one or more.

As another drawback of the SVM RBF, NN, and other conventional classification strategies, Examples 8 to 10 above described experiments in which the SVM RBF and NN models were given a significant advantage over the RE* models of the present invention. Specifically, in each of these examples, there were two newly encountered classes used to simulate counterfeits in the marketplace. With respect to the RE* models of the present invention, no AI model training occurred with respect to these simulated counterfeit classes so that each RE* model was challenged to recognize these for the first time during performance testing. The challenge was that these newly encountered samples from newly encountered classes had to be recognized as being outside any of the known classes for which training had occurred.

In contrast, neither the SVM RBF model nor the NN model was challenged this way inasmuch as it was known that each of these two models would tend to wrongly force such newly encountered samples to be in one of the known classes. The consequence is that the SVM RBF and NN models would misclassify 100% of such newly encountered samples. This means that the SVM RBF and NN models tend to be unable to recognize newly encountered classes. To avoid this real-world drawback in Examples 8 to 10, and in contrast to the RE* models, the two simulated counterfeits were grouped into a single counterfeit class in each of Examples 8 to 10, respectively. In short, the counterfeit classes were known to the SVM RBF and NN models during training but completely unknown to the RE* models. Even with such a significant advantage give to the SVM RBF and NN models, the RE* strategies still provided better classification performance in Examples 8 to 10.

The favored treatment of the SVM RBF and NN models in Examples 8 to 10 generally would not be realistic. In actual practice, it is much more likely that training will occur with respect to some known and/or predicted classes, and yet after training when the models are being used for classification, new, unknown classes will be encountered for the first time. This could occur, for example, if competitors introduce new products or new counterfeits into the marketplace. Accordingly, more realistic scenarios occur when trained classification models encounter new classes for the first time after training. Of course, model training can be updated after the new classes are analyzed and detected such as by human efforts. However, until updated training occurs with respect to such newly encountered classes, the RE* models of the present invention are much better and earlier at recognizing these new classes than the SVM RBF and NN models. Indeed, as will be shown by the data below, the RE* models provide high accuracy in this more realistic context. In the meantime, the SVM RBF and NN models are highly inaccurate and perform much worse than in the more favorable scenario of Examples 8 to 10.

This evaluation used 18 classes (Classes 1 to 18, respectively) based on 16 different taggant systems, respectively. Each of classes 1 to 16 was a unique taggant system. The taggant systems were incorporated into carrier inks to provide corresponding taggant inks that were printed on substrates. Each of the unique taggant systems in Classes 1 to 16 provides a unique spectral signature. Class 1 of this Example is the same as Class 1 in Example 6.

Each of Classes 17 and 18 was a variation of Class 1. Class 17 was formulated to use exactly the same taggant system as Class 1 except that the weight loading of the taggant system in its ink carrier was higher in Class 17 than that used in Class 1. Class 18 was formulated to use exactly the same taggant system as Class 1 except that the weight loading of the taggant system in its ink carrier was lower in Class 18 than that used in Class 1. Thus, Class 17 can also be referred to as Class 17 (High) to indicate its higher taggant loading, while Class 18 can be referred to as Class 18 (Low) to indicate its lower taggant loading. Classes 17 and 18 of this Example are the same as Classes 12 and 13, respectively, in Example 6.

The RE* models used in Examples 12 to 14 had the same architecture as the RE* models of Example 7. Examples 12 to 14 also used the same SVM RBF and NN models as example 7. The SVM RBF, NN, and RE* models were trained using 500 iterations.

Scans of the samples were taken. Some of the scans were used for training and the remainders were reserved for testing the performance of the trained models. To obtain each scan, a scan of the fluorescent emission of each sample was taken using a detector with a 5-channel color chip. The scan obtained a value for each color channel. To trigger emission of the fluorescent signature of each sample, the sample was illuminated with an LED light source at a wavelength of 385 nm. Scans of the samples used to test the trained models were obtained in the same way. Examples 12 to 14 describe classification experiments undertaken using the scans from the Class 1 to 18 samples.

### Example 12

In this experiment, SVM RBF, NN, and RE* models were trained for Classes 1 and 2 of Example 11 through 500 training iterations. Training the RE* models involved training one specialized AI model for each class for a total of 2 trained, specialized AI models. Each RE* model was trained using only training scans for the associated class. For each of the SVM RBF and NN strategies, a single model was trained with respect to Classes 1 and 2. Scans from Classes 3 to 18 were not used for training. In subsequent testing of the trained models, this simulated that classes 3 to 18 were newly encountered for the first time after training.

After training, the abilities of the trained SVM RBF, NN, and RE* models to accurately classify the scans from all of Classes 1 to 18 were evaluated. This evaluation tested not only the ability of the models to accurately classify scans from Classes 1 and 2 into Classes 1 and 2, respectively, but also to recognize that scans from Classes 3 to 18 did not belong in Class 1 or 2. The accuracy results of the experiment shown as the percentage of samples that are correctly classed are shown in the following table. The reconstruction error (RMSE) threshold for each of the RE* models was set at 0.96. Note that this error threshold was selected so that 96% of the training samples in the class being trained were correctly classified.

| Training | SVM RBF Model | NN Model | RE* models |
|---|---|---|---|
| 500 iterations | 8.9% | 10.6% | 82.2% |

The results show that the SVM RBF and NN models had extremely low accuracy when trained for only two of the 18 classes. The poor results from these two models resulted because neither could recognize any of the Class 3 to 18 scans being outside Classes 1 and 2. Instead, each conventional model inaccurately classified the Class 3 to 18 scans as being in Class 1 or 2.

In contrast, the RE* models provided much higher classification accuracy, showing that the RE* models were much better at not only classifying the Class 1 and Class 2 scans into the proper classes but also to recognize that the Class 3 to 18 scans did not belong in Class 1 or Class 2.

### Example 13

In this experiment, SVM RBF, NN, and RE* models were trained for Classes 1-5, 7-10, and 12-16 of Example 11 through 500 training iterations. Training the RE* models involved training one specialized AI model for each class for a total of 14 trained, specialized AI models. Each RE* model was trained using only training scans for the associated class. For each of the SVM RBF and NN strategies, a single model was trained with respect to Classes 1-5, 7-10, and 12-16. Scans from Classes 6, 11, 17, and 18 were not used for training. In subsequent testing of the trained models, this simulated that Classes 6, 11, 17, and 18 were newly encountered for the first time after training.

After training, the abilities of the trained SVM RBF, NN, and RE* models to accurately classify the scans from all of Classes 1 to 18 were evaluated. This evaluation tested not only the ability of the models to accurately classify scans from Classes 1-5, 7-10, and 12-16 into Classes 1-5, 7-10, and 12-16, respectively, but also to recognize that scans from Classes 6, 11, 17, and 18 did not belong in Classes 1-5, 7-10, and 12-16. The accuracy results of the experiment shown as the percentage of samples that are correctly classed are shown in the following table. The reconstruction error threshold for each of the RE* models was set at 0.96 such that 96% of the samples in the class whose model was being trained were classified accurately.

| Training | SVM RBF Model | NN Model | RE* models |
|---|---|---|---|
| 500 iterations | 61.1% | 49.4% | 83.8% |

The results show that the SVM RBF and NN models had much lower accuracy than the RE* strategy of the present invention. The poor results from these two models resulted at least in part because neither could recognize any of the Class 6, 10, 17, and 18 scans being outside Classes 1-5, 7-10, and 12-16. Instead, each model inaccurately classified the Class 6, 11, 17 and 18 scans as being in Classes 1-5, 7-10, and 12-16.

In contrast, the RE* models provided much higher classification accuracy, showing that the RE* models were much better at not only classifying the Classes 1-5, 7-10, and 12-16 scans into the proper classes but also to recognize that the Class 6, 11, 17, and 18 scans did not belong in Classes 1-5, 7-10, and 12-16.

### Example 14

In this experiment, SVM RBF, NN, and RE* models were trained for Classes 1 to 18 through 500 training iterations. Training the RE* models involved training one specialized AI model for each class for a total of 18 trained, specialized AI models. Each RE* model was trained using only training scans for the associated class. For each of the SVM RBF and NN strategies, a single model was trained with respect to Classes 1 to 18. This simulated a situation in which all of the scans used to test the models were known to the models during training.

After training, the abilities of the trained SVM RBF, NN, and RE* models to accurately classify the scans from all of Classes 1 to 18 were evaluated. The accuracy results of the experiment shown as the percentage of samples that are correctly classed are shown in the following table. The reconstruction error threshold for each of the RE* models was set at 0.96 such that 96% of the samples whose AI model was being trained were accurately classified.

| Training | SVM RBF Model | NN Model | RE* models |
|---|---|---|---|
| 500 iterations | 39.4% | 77.2% | 90.6% |

The results show that the SVM RBF and NN models had much lower accuracy than the RE* strategy of the present invention even though all the scans used for testing came from known classes. The poor results from the SVM RBF and NN models resulted at least in part because, due to the low resolution of the scans and in contrast to the RE* strategy, the conventional methods were not able to effectively distinguish the spectral signatures of the samples.

In contrast, the RE* models provided much higher classification accuracy, showing that the RE* models were much better at classifying all the scans, including classifying among Classes 1, 2, 17 and 18. Since Classes 17 and 18 were similar to Class 1 but for intensity of the taggant signatures, each of Classes 17 and 18 can be viewed as a “super counterfeit” of Class 1 for purposes of this example. A super counterfeit in general refers to a class that is a fake but has a spectral signature that is extremely close to the spectral signature of the authentic class. This simulates the excellent abilities of the RE* strategy of the present invention to distinguish super counterfeits from authentic samples.

### Example 15

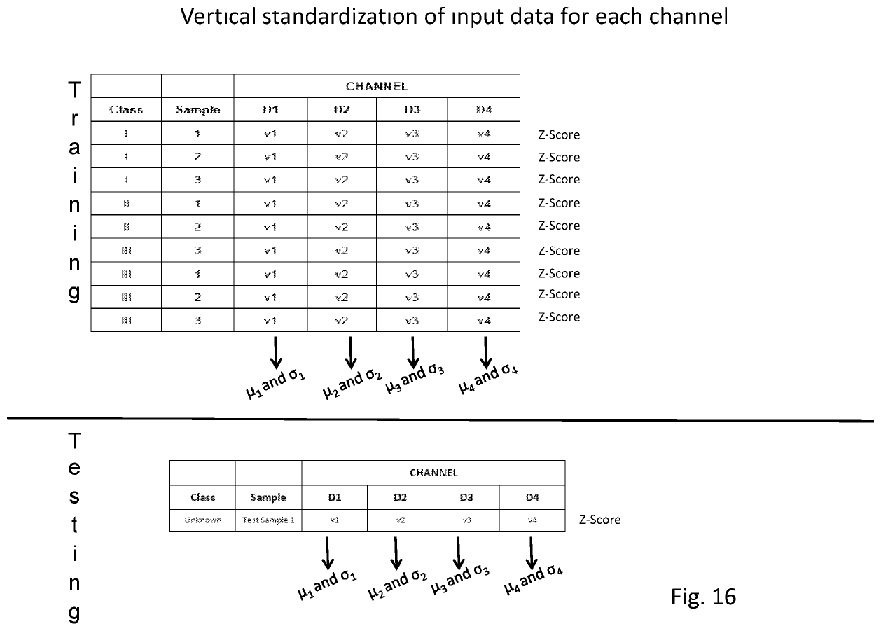

Using different strategies to standardize the values of an input data set can impact the classification accuracy of classification models, including the SVM RBF, NN, and RE* models of Examples 11-14. FIGS. 15 and 16 each shows how the input data values for samples can be tabulated so that the input data values for each sample are in a row and the values for each data channel are in columns. For purposes of illustration, Each of FIGS. 15 and 16 show a tabulation for three classes of samples, wherein each class has three samples in the class. Further, each sample has an input data set of four data values v1 to v4 in four data channels D1 to D4, respectively.

In order to convert the input data into a form more suitable for training and/or testing, the data can be standardized either horizontally as shown in FIG. 15 or vertically as shown in FIG. 16. Horizontal standardization results when the data values from multiple channels for a particular sample are standardized. Vertical standardization results when the data values for a particular channel for multiple samples are standardized.

Horizontal standardization tends to be more secure than vertical standardization because standardization across multiple channels does not indicate the proper channel values for an authentic item. Vertical standardization tends to be less secure, because it reveals proper channel values to counterfeiters or others who might want to copy an authentic spectral signature. Yet, vertical standardization allows a variety of classification strategies to be more accurate.

For example, in two experiments, SVM RBF, NN, and RE* models were trained with respect to only Classes 1 and 2 of Classes 1 to 18 of Example 11. Then the trained models were tested to see how accurately they could classify the Class 1 to 18 samples as being inside or outside Classes 1 and 2. In one experiment, the models were trained and tested using input data with horizontal standardization. In the other experiment, the modes were trained and tested using input data with vertical standardization. The results of the two experiments are shown in the following table using 0.96 (i.e., such that 96% of the samples in the model being trained are classified accurately) as the reconstruction error (RMSE) threshold for the RE* models:

| Standardization | SVM RBF | NN | RE* |
|---|---|---|---|
| Horizontal | 8.9% | 10.6% | 82.2% |
| Vertical | 10.0% | 10.6% | 97.2% |

The same experiment was repeated except that Classes 1 to 14 of Example 11 were used to train the models before testing the ability to accurately classify scans from all of Classes 1 to 18 of Example 11. The results of the two experiments are shown in the following table using 0.96 (96% of the samples in the class whose AI model is being trained are classified accurately) as the reconstruction error (RMSE) threshold for the RE* models:

| Standardization | SVM RBF | NN | RE* |
|---|---|---|---|
| Horizontal | 61.1% | 49.4% | 83.8% |
| Vertical | 75.0% | 61.7% | 87.8% |

The same experiment was repeated except that all of Classes 1 to 18 of Example 11 were used to train the models before testing the ability to accurately classify scans from all of Classes 1 to 18 of Example 11. The results of the two experiments are shown in the following table using 0.96 (96% of the samples in the class whose AI model is being trained are classified accurately) as the reconstruction error (RMSE) threshold for the RE* models:

| Standardization | SVM RBF | NN | RE* |
|---|---|---|---|
| Horizontal | 39.4% | 77.2% | 90.6% |
| Vertical | 96.7% | 82.2% | 90.0% |

The data in the tables of this example show how all three of the models tend to classify more accurately when vertical standardization is used. Hence, choosing between horizontal or vertical standardization can involve balancing factors such as security and accuracy. For example, using horizontal standardization may be used when security is paramount. Vertical standardization may be used in scenarios such as quality control applications or the like for which accuracy is paramount.

All patents, patent applications, and publications cited herein are incorporated herein by reference in their respective entities for all purposes. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. (canceled)

2. A method for determining whether a sample is in a class, comprising the steps of:
a) obtaining optical information from the sample;
b) using the optical information to provide an input dataset that comprises information indicative of the spectral data characteristics associated with the sample;
c) causing a computer processor to access an AI model stored in a computer memory and to use the AI model to carry out steps comprising transforming information comprising the input dataset to provide a reconstructed dataset, said transforming comprising compressing and decompressing a flow of data derived from the information comprising the input dataset, wherein a reconstruction error associated with the input data set and the reconstructed dataset is indicative of whether the sample is in the class; and
d) using information comprising the reconstruction error to determine if the sample is in the class.

3. The method of claim 2, wherein the transforming comprises compressing the input dataset in one or more compression stages to provide compressed data and then decompressing the compressed data in one or more stages to provide the reconstructed dataset.

4. The method of claim 2, wherein the transforming comprises expanding the input dataset in one or more expansion stages to provide expanded data and then compressing the expanded data in one or more stages to provide the reconstructed dataset.

5-7. (canceled)

8. The method of claim 2, wherein said transforming comprises using a trained, specialized AI model associated with the class to transform the input dataset into the reconstructed dataset.

9. The method of claim 2, wherein the method comprises determining whether the sample is in a class of a plurality of classes, and wherein the method further comprises the step of providing a plurality of trained, specialized AI models associated with the plurality of classes, respectively, and wherein step c) is repeated in a manner such that each AI model is used to transform the input dataset into an associated reconstructed dataset and such that a reconstruction error is determined for each of the reconstructed datasets, and wherein step d) comprises using information comprising the reconstruction errors to determine if the sample is in a class associated with any of the trained, specialized AI models.

10-17. (canceled)

18. The method of claim 2, wherein the input dataset comprises intensity values for a spectrum as a function of wavelength over a wavelength range.

19-29. (canceled)

30. The method of claim 3, wherein the number of compression stages is different than the number of decompression.

31. The method of claim 4, wherein the number of compression stages is different than the number of decompression stages.

32-33. (canceled)

34. A method of making a system that determines information indicative of whether a sample is in a class, comprising the steps of:
a) providing a training sample set comprising a plurality of training samples associated with the class;
b) providing an input dataset for each of the training samples, wherein each input dataset characterizes a corresponding training sample of the training sample set;
c) providing an artificial intelligence (AI) model that transforms the input dataset of each training sample into an associated reconstructed dataset, wherein the transforming comprises compressing a flow of data and decompressing or expanding a flow of data, and wherein a reconstruction error associated with each reconstructed dataset characterizes differences between the input dataset for each training sample and the associated reconstructed dataset; and
d) using information comprising the input datasets, the reconstructed datasets, and the reconstructions errors to train the AI model such that the reconstruction errors are indicative the training samples are in the class.

35. (canceled)

36. The method of claim 34, wherein the input dataset for each training sample characterizes an authentic taggant signature associated with the class, and wherein step d) comprises training the AI model to transform the input data sets into reconstructed datasets that match the input datasets within an error specification.

37-43. (canceled)

44. The method of claim 34, wherein each of the reconstruction errors is a value derived from an array of comparison values.

45-55. (canceled)

56. The method of claim 34, wherein step d) comprises compressing the input dataset in a plurality of compression stages to provide compressed data and then decompressing the compressed data in a plurality of stages to provide the reconstructed dataset.

57. The method of claim 34, wherein step d) comprises expanding the input dataset in a plurality of expansion stages to provide expanded data and then compressing the expanded data a plurality of stages to provide the reconstructed dataset.

58-61. (canceled)

62. The method of claim 34, further comprising updating the trained AI model over time.

63-68. (canceled)

69. The method of claim 36, wherein the input dataset comprises intensity values for a spectrum as a function of wavelength over a wavelength range.

70-73. (canceled)

74. The method of claim 34, wherein the characteristics associated with the sample comprise optical information harvested from the sample or a component thereof.

75. The method of claim 74, wherein the optical information comprises spectral characteristics.

76-78. (canceled)

79. The method of claim 34, wherein step d) comprises progressively compressing a data flow and then progressively decompressing the data flow.

80. The method of claim 34, wherein step d) comprises progressively expanding a data flow and then progressively compressing the data flow.

81. The method of claim 56, wherein the number of compression stages is different from the number of decompressing or compressing stages.

82. The method of claim 57, wherein the number of compressing stages is different from the number of decompressing or compressing stages.

83. (canceled)

84. A method of making a system that determines information indicative of whether a sample is in a class associated with an authentic taggant system, comprising the steps of:
a) providing the authentic taggant system, wherein the authentic taggant system exhibits spectral characteristics associated with an authentic spectral signature;
b) providing a plurality of training samples, wherein each training sample comprises the authentic taggant system, and wherein the authentic taggant system exhibits spectral characteristics associated with an authentic spectral signature;
c) obtaining the spectral characteristics of the authentic spectral signature from each of the training samples;
d) using the spectral characteristics obtained from the training samples to provide an input dataset for each of the training samples, wherein each of the input datasets comprises information indicative of the spectral characteristics exhibited by the authentic taggant system;
c) providing an artificial intelligence (AI) model that compresses and decompresses a flow of data from each of the input datasets to provide an associated, reconstructed dataset, wherein a reconstruction error associated with each of the reconstructed data sets characterizes differences between each input dataset and the associated reconstructed dataset; and
d) using information comprising the input datasets, the reconstructed datasets, and the reconstruction errors to train the AI model such that the reconstruction errors are indicative that the training samples are in the class.

85. (canceled)
